(19) United States
(12) Patent Application Publication
(10) Pub. No.: US 2026/0289508 A1
(43) Pub. Date: Sep. 24, 2026

(54) SYSTEM

(71) Applicant: SoftBank Group Corp., Tokyo (JP)

(72) Inventor: Mari ANDO, Tokyo (JP)

(73) Assignee: SoftBank Group Corp., Tokyo (JP)

(21) Appl. No.: 19/561,760

(22) Filed: Mar. 10, 2026

(30) Foreign Application Priority Data
Mar. 19, 2025 (JP) 2025-044537

(51) Int. Cl. G06Q 10/105; G06F 40/284; G06N 3/0475

(52) U.S. Cl. CPC G06Q 10/105; G06F 40/284; G06N 3/0475

(57) ABSTRACT

A system includes a processor that is configured to receive a consultation from a user, analyze consultation content received from the user and recognize an emotional state of the user by using a natural language processing technique, analyze, by using a generative AI model, public compliance issues based on the analyzed emotional state and the consultation content, input a prompt to the generative AI model to instruct the generative AI model to generate a general opinion based on a result of the analysis, and identify, based on the generated general opinion and the emotional state of the user, a specific department or person to suggest as a consultation destination.

### CROSS-REFERENCE TO RELATED APPLICATION

This application is based on and claims priority under 35 USC 119 from Japanese Patent Application No. 2025-044537 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional consultation support systems and compliance reporting tools generally focus on collecting factual information from users and providing static guidance or routing based on pre-defined rules. Such systems do not adequately account for the emotional state of the user, even though the user's emotional condition (for example, anxiety, fear, anger, or distress) strongly influences both the interpretation of the consultation content and the appropriateness of the advice or referral destination. As a result, a system may misinterpret the seriousness or urgency of a case, generate generic or insensitive responses, or suggest an inappropriate consultation destination that does not match the user's psychological needs or the true nature of the compliance issue. In addition, existing systems typically do not leverage advanced generative AI models in combination with emotional analysis and real-world compliance knowledge, limiting the depth and contextual relevance of the opinions and recommendations provided.

Accordingly, there is a need for a system that is capable of recognizing the emotional state of the user from the consultation text, analyzing compliance-related issues in society by using a generative AI model while taking the emotional state into account, and suggesting specific departments or persons as appropriate consultation destinations based on both the generated opinion and the user's emotional condition. There is also a need for such a system to utilize learned data including public compliance cases, laws and regulations, and actual consultations so that the analysis and recommendations are practically useful and aligned with real compliance practice.

### SUMMARY

In order to solve the above-mentioned problems, according to one aspect of the present invention, there is provided a system comprising a processor, wherein the processor is configured to receive a consultation from a user, analyze consultation content received from the user and recognize an emotional state of the user by using a natural language processing technique, analyze, by using a generative AI model, public compliance issues based on the analyzed emotional state and the consultation content, input a prompt to the generative AI model to instruct the generative AI model to generate a general opinion based on a result of the analysis, and identify, based on the generated general opinion and the emotional state of the user, a specific department or person to suggest as a consultation destination.

In some embodiments, the processor is configured to train on public compliance cases, laws and regulations, and actual consultations, and input a prompt to the generative AI model to instruct the generative AI model to perform analysis while taking emotional data into account. In certain embodiments, the processor is configured to specify the specific department or the person based on the analysis result obtained from the generative AI model while taking the emotional state of the user into account. By combining recognition of the user's emotional state, a generative AI model trained on compliance-related data, and destination selection logic that considers both factual and emotional aspects, the system can provide contextually appropriate opinions and accurately suggest suitable consultation destinations.

The term “system” refers to an integrated combination of hardware and software components, including at least one processor and associated memory and communication interfaces, that collectively perform the claimed functions.

The term “processor” refers to one or more hardware processing units, such as a central processing unit (CPU), a graphics processing unit (GPU), or a dedicated AI accelerator, or any combination thereof, capable of executing instructions to perform the claimed operations.

The term “consultation” refers to an inquiry, report, concern, or request for advice provided by a user, typically in textual form, regarding a problem, incident, or situation, including but not limited to compliance-related issues in an organization or society.

The term “user” refers to a person who accesses and interacts with the system, provides consultation content, and receives opinions, analysis results, or suggested consultation destinations from the system.

The term “consultation content” refers to the information included in a consultation, typically expressed in natural language text, describing facts, circumstances, feelings, or opinions about a particular issue or concern.

The term “emotional state” refers to a psychological or affective condition of the user, such as anxiety, fear, anger, sadness, relief, or similar emotions, inferred from the consultation content or related data.

The term “natural language processing technique” refers to a computational method or algorithm for processing, analyzing, or understanding human language text, including but not limited to tokenization, part-of-speech tagging, sentiment analysis, emotion recognition, and semantic analysis.

The term “generative AI model” refers to a machine learning model that is capable of generating new text or content, such as a large language model or other generative model, based on input data, prompts, or context provided by the system.

The term “public compliance issues” refers to compliance-related matters observed in society or within organizations, including but not limited to legal violations, policy breaches, ethical misconduct, harassment, fraud, and other behavior subject to laws, regulations, or internal rules.

The term “general opinion” refers to a system-generated explanatory or advisory statement that provides an overall view, assessment, or interpretation of the consultation content and related compliance issues, without being limited to a specific legal judgment in a particular jurisdiction.

The term “prompt” refers to text or structured input data provided to the generative AI model by the processor, which instructs or guides the generative AI model as to the task to perform, the perspective to adopt, or the type of output to generate.

The term “analysis result” refers to information produced by the generative AI model or other processing modules, including intermediate or final findings, interpretations, classifications, or assessments derived from the consultation content and related data.

The term “specific department” refers to a particular organizational unit, such as a human resources department, compliance department, legal department, internal audit department, or similar division, that can receive and respond to the user's consultation.

The term “person” refers to an individual, such as a manager, counselor, compliance officer, legal advisor, or hotline operator, who is designated as a potential consultation destination for the user.

The term “consultation destination” refers to a specific department or person to whom the user is recommended or guided to communicate the consultation for further handling, advice, or resolution.

The term “public compliance cases” refers to known or recorded instances of compliance-related incidents, whether internal to an organization or publicly disclosed, that can be used as training data or reference examples for the system.

The term “laws and regulations” refers to statutory provisions, governmental regulations, ordinances, guidelines, and other legally binding or authoritative rules relevant to compliance issues addressed by the system.

The term “actual consultations” refers to real consultation records, inquiries, or reports made by users or employees in the past, anonymized or otherwise processed as necessary, which are used as data for training or improving the generative AI model.

The term “emotional data” refers to data representing or derived from the emotional state of the user, such as emotion labels, sentiment scores, intensity levels, or similar indicators, obtained from analysis of the consultation content or related information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

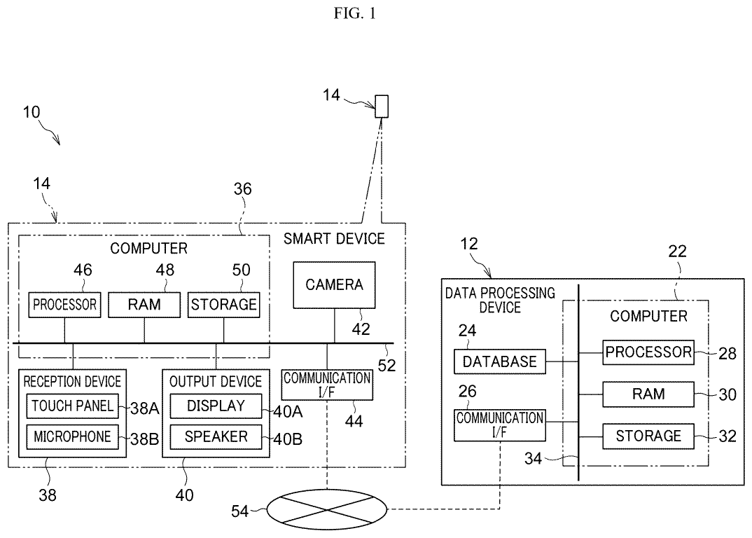

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

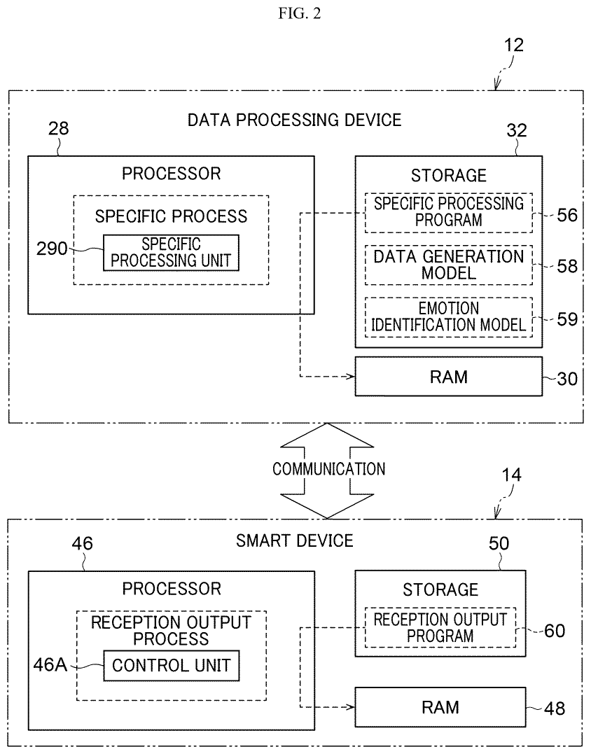

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional consultation support systems that merely relay user questions to a generative AI model and return the generated text are generally optimized for content generation, but not for improving the underlying operation of computer systems that mediate complex, emotionally loaded consultations. Such systems typically treat the user input as a flat text string, invoke a generic model prompt, and display the model output without leveraging structured emotional context, accumulated domain data, or multi-turn dialogue history. As a result, the computational pipeline does not effectively guide the generative AI model, leading to unstable output quality, lack of reproducibility, and inefficient utilization of processing and network resources.

In particular, when handling compliance-related consultations or other sensitive matters, existing systems often fail to: (i) reliably recognize the user's emotional state at the time of input, (ii) integrate that emotional state with structured domain knowledge such as past cases and norms, and (iii) direct the model to generate machine-processable responses that can be used to automatically identify appropriate consultation destinations. This results in ad hoc prompt engineering performed externally by human operators, increased processing latency due to repeated trial-and-error queries, and a heavy cognitive burden on downstream personnel who must interpret unstructured outputs.

From a computing technology perspective, there is a need for an improved server-side architecture and control method that: (a) systematically converts unstructured consultation text into structured context information including emotional state and dialogue history, (b) dynamically generates prompt sentences that encode analysis conditions and output formats tailored to a generative AI model, and (c) automatically transforms the model's response into structured display data and routing information (e.g., appropriate organizational units or responsible entities). Such an architecture should enhance the deterministic behavior of the overall pipeline, reduce unnecessary network round trips and computation, and provide a more predictable and controllable interface to the generative AI model, thereby improving the functioning of the computer system as a whole rather than merely automating human mental steps.

The specific processing by the specific processing unit 290 of the data processing device 12 in Example 1 is realized by the following means.

The present invention provides a server comprising a processor configured to receive consultation information input by a user via a terminal, analyze the consultation information using a natural language processing technique to recognize an emotional state of the user, generate, based on the consultation information and the emotional state, a prompt sentence that specifies analysis conditions and an output format for a generative AI model, transmit request data including the prompt sentence to the generative AI model and acquire structured response information from the generative AI model, extract one or more consultation destination candidates based on the response information and the emotional state and identify a specific organizational unit or responsible entity from the consultation destination candidates, convert the response information and the identified organizational unit or responsible entity into display data that is outputtable on a display screen of the terminal, manage, as dialogue history, a plurality of pieces of consultation information and a plurality of pieces of response information, and incorporate context information including the dialogue history and the emotional state into the prompt sentence in subsequent processing. This enables the server to implement a technically improved consultation support pipeline in which unstructured user inputs are transformed into structured, context-rich prompt sentences and responses, thereby enhancing control over the behavior of the generative AI model, improving the determinism and efficiency of server-side processing and network communication, and automatically producing machine-processable routing information and display data suitable for continuous consultations.

The term “system” refers to a combination of one or more hardware devices and software components that cooperate to execute the consultation processing described in the claims, including at least a processor and one or more terminals connected via a communication network.

The term “processor” refers to one or more hardware processing units, such as a central processing unit or a processing circuit, configured by software instructions to perform the functions of receiving, analyzing, generating, transmitting, and managing data as recited in the claims.

The term “terminal” refers to an information processing device operated by a user, such as a personal computer, a mobile communication device, or another display-equipped computing device, capable of transmitting consultation information to the system and receiving display data from the system.

The term “consultation information” refers to electronic text data or equivalent digital data that represents a user's inquiry, concern, problem description, or request for advice, input via a terminal and transmitted to the system.

The term “natural language processing technique” refers to a software-implemented information processing method that programmatically analyzes human language text, including but not limited to tokenization, syntactic analysis, semantic analysis, and sentiment or emotion detection.

The term “emotional state” refers to an inferred psychological condition of a user, such as anxiety, distress, anger, or neutrality, which is recognized by the processor based on the content and expression of the consultation information.

The term “generative AI model” refers to a machine-learned information processing model, such as a large-scale language model, configured to generate natural language output by probabilistically predicting token sequences in response to input data including a prompt sentence.

The term “prompt sentence” refers to a structured piece of input data, including text or equivalent digital representation, that provides instructions, conditions, and context to the generative AI model, thereby controlling analysis operations and characteristics of generated responses.

The term “request data” refers to electronic data transmitted from the processor to the generative AI model, the data including at least the prompt sentence and optionally additional parameters specifying analysis conditions or output control values.

The term “response information” refers to electronic data output by the generative AI model and received by the processor, the data including at least a general opinion, advice, or other generated content in response to the prompt sentence.

The term “general opinion” refers to model-generated explanatory content, evaluation, or analysis result that abstracts from an individual consultation case to present a more generalized or typical viewpoint.

The term “advice” refers to model-generated guidance, recommendations, or suggested actions tailored to the consultation information and, optionally, to the user's emotional state.

The term “consultation destination candidate” refers to data representing one or more possible targets to which a consultation may be directed, such as abstract representations of organizational categories, functional units, or roles suitable for handling the consultation.

The term “organizational unit” refers to a functional or administrative subdivision within an organization, such as a department, a section, a team, or an equivalent grouping, that can be identified as a target for handling a consultation.

The term “responsible entity” refers to an abstract representation of a person, group, or role within an organization that can be designated as in charge of or appropriate for addressing the consultation.

The term “display data” refers to electronic data formatted for visual presentation on a display device of the terminal, the data including at least the response information and, when applicable, information identifying an organizational unit or responsible entity.

The term “communication control function” refers to a hardware and software combination, such as a network interface and communication protocol stack, that transmits and receives data between the processor and the terminal or between the processor and an external model-execution environment.

The term “learning target information” refers to data accumulated by the processor for use in configuring or guiding analysis by the generative AI model, including consultation information, domain-related cases, normative information, and past consultation histories. The term “compliance-related cases” refers to documented or recorded instances of conduct, incidents, or issues associated with rules, regulations, or organizational policies, which are used as part of the learning target information.

The term “norm information” refers to data representing external or internal rules, guidelines, policies, standards, or regulations that define appropriate behavior or procedures in an organization or society.

The term “past consultation histories” refers to stored records of previous consultations and corresponding responses, including time information, consultation content, and outcome information.

The term “analysis conditions” refers to parameters or constraints specified in the prompt sentence, such as required perspective, level of detail, tone, or domain focus, that control how the generative AI model performs its analysis.

The term “output format” refers to a structure or pattern specified in the prompt sentence that constrains the form of the generative AI model's response, such as bullet points, step-by-step instructions, labels, or other predefined layouts.

The term “dialogue history” refers to a sequence of multiple pieces of consultation information and corresponding response information stored by the processor and representing a multi-turn interaction between a user and the system.

The term “context information” refers to data that characterizes the circumstances of a consultation, including at least the dialogue history and the emotional state, and that is incorporated into the prompt sentence to enable context-aware processing by the generative AI model.

The term “continuous consultations” refers to a series of related consultation exchanges over time between a user and the system, in which later consultations are influenced by or dependent on earlier consultations and responses.

In one embodiment, a server executes a consultation support system that interacts with one or more terminals operated by users. The system is implemented on general-purpose computer hardware, and software modules executed by a processor in the server cooperate with software executed on the terminals to perform consultation analysis, prompt sentence generation, interaction with a generative AI model, and output control.

### A. Hardware and Software Configuration

Server uses a computing platform that includes at least one central processing unit, a main memory, a non-volatile storage device, a network interface controller, and a display interface. Server may be implemented on a physical machine or a virtual machine provided by an infrastructure service. Server executes an operating system such as a general-purpose server operating system, as well as middleware components including a web server and an application server.

Server executes an application program that is divided into multiple modules, including at least a communication control module, a natural language processing module, a prompt generation module, a generative AI interaction module, an emotional state estimation module, a consultation destination determination module, a dialogue history management module, and a display data generation module. Server may store consultation information, dialogue history, and model configuration data in a relational database management system such as a general-purpose database.

Terminal uses a computing device such as a personal computer, a smartphone, or a tablet. Terminal executes a client operating system such as a general-purpose client OS and a web browser such as a generic browser. Terminal may execute a client-side application implemented as a web application using a scripting language and a user interface library. Terminal includes a display device such as a liquid crystal display or an organic light-emitting diode display, an input device such as a keyboard or touch panel, a network interface, and a memory.

User operates terminal to access a web page or an application screen provided by server. User inputs consultation information as natural language text into a text input field displayed on terminal.

### B. Data Structures and Internal Representations

Server uses a structured internal representation for consultation information. In one embodiment, server represents consultation information as a record that includes at least a text field that stores the consultation content, a user identifier, a timestamp, a language code, and one or more emotional state fields. Server stores dialogue history as a sequence of such records linked by a conversation identifier.

Server uses a feature vector representation for the emotional state. Emotional state estimation module maps consultation text to a numerical vector in a feature space. The vector includes components representing sentiments such as positive, negative, or neutral, and emotion categories such as anxiety, anger, sadness, or calmness. The feature vector may also include a confidence score for each emotion category. Server stores the emotional state feature vector as part of the consultation record.

Server also uses a structured representation for consultation destinations. Consultation destination determination module refers to a table of organizational units and responsible entities. The table includes fields such as an organizational category, a specific unit name, a role classification, and one or more keywords or tags that correspond to typical consultation topics. Server associates consultation destination candidates with consultation information based on similarity between extracted features from the text and attributes of the destination table.

Server uses a prompt structure in which a prompt sentence includes a system instruction part, an optional developer instruction part, and a user content part. Prompt generation module stores multiple templates for system instructions and uses one of them depending on the consultation type and emotional state. Prompt generation module concatenates these parts into a single text sequence that is compatible with a generative AI model interface.

### C. Natural Language Processing and Emotional State Estimation

Server preprocesses consultation information using the natural language processing module. Natural language processing module performs tokenization, part-of-speech tagging, and syntactic parsing using a language model or a rule-based parser. Natural language processing module removes or masks personally identifiable information based on pattern matching rules to improve privacy and to normalize input to the generative AI model.

Server uses emotional state estimation module to infer emotional state from the consultation text. Emotional state estimation module uses a statistical classifier or a neural network that has been trained on labeled emotional text data. In one embodiment, emotional state estimation module uses a multilayer neural network that receives as input a sequence of word embeddings or subword embeddings, computes intermediate representations using recurrent, convolutional, or transformer layers, and outputs a probability distribution over multiple emotion categories. The module uses a loss function such as cross-entropy during training and updates weights using an optimization algorithm such as stochastic gradient descent or a variant. At runtime, server applies the trained model to produce an emotional state feature vector that is stored and further used in prompt generation and consultation destination determination.

### D. Generative AI Model Structure and Learning

Server interacts with a generative AI model that is implemented as a neural network using a transformer architecture. The generative AI model includes an embedding layer that maps input tokens to continuous vectors, a plurality of self-attention layers that compute context-dependent representations, and an output layer that produces probability distributions over vocabulary tokens. The model parameters are obtained through pre-training on large-scale text corpora and may be further fine-tuned on compliance-related data, consultation records, or other domain-specific text.

Server assumes that the generative AI model has been trained by minimizing a loss function such as a negative log-likelihood of correct next tokens over large training datasets. Model training uses an optimization algorithm such as Adam. Training may include regularization techniques such as dropout and layer normalization. Data augmentation methods, including synonym substitution or back-translation, may be used to increase variety in training examples.

Server uses an application programming interface to send input sequences and receive output sequences from the generative AI model. The input includes a prompt sentence that encodes analysis conditions and expected output formats. The generative AI model processes the input sequence and returns a sequence of output tokens that server decodes into natural language text. The model outputs both content generated as a general opinion and content formatted in a structured way as required by the prompt.

### E. Prompt Generation and Control of Model Behavior

Server uses prompt generation module to produce a prompt sentence that systematically controls behavior of the generative AI model. Prompt generation module receives a consultation record and associated emotional state feature vector and dialogue history.

Server selects a system instruction template according to the consultation domain and emotional state. For example, for counseling-oriented consultations, server may use a system instruction such as:

“You are a professional counseling assistant. Provide empathetic and practical advice in a polite tone. Consider the user's emotional distress level and avoid harsh expressions.”

For compliance-related consultations, server may use a system instruction such as:

“You are a compliance analysis assistant. Provide general opinions based on typical compliance practices and organizational norms. Do not provide legal conclusions, but explain risk factors and recommend appropriate organizational units.”

Server constructs the user content portion of the prompt sentence by concatenating the current consultation text with selected elements of dialogue history. Server includes prior questions and prior responses that are relevant to the current consultation. Server may abbreviate or summarize older history using a text summarization algorithm to control the total length.

Server incorporates emotional state information into the prompt sentence using explicit wording. For example, server may add a line such as:

“The user appears to be highly anxious and distressed based on the wording and style of the consultation.”
or

“The user appears to be calm and primarily seeking factual guidance.”

Such explicit embedding of emotional state into the prompt sentence allows the generative AI model to condition its response style and content on user emotion in a consistent manner, improving the stability and appropriateness of responses.

In one specific example, server constructs the following prompt sentence for a counseling consultation:

System: You are a professional counseling assistant. Provide empathetic, practical advice in Japanese. Consider that the user is feeling low motivation and some anxiety about work.

User: I've been feeling unmotivated at work lately. What should I do?

In another example for an internal technical support consultation, server constructs the following prompt sentence:

System: You are an internal IT helpdesk assistant. Answer in Japanese and be concise. Provide step-by-step troubleshooting instructions. Consider that the user is frustrated but not in an emergency situation.

User: I can't connect to my company's VPN. I get an error when I try to connect from my home Wi-Fi. What should I check?

By encoding specific instructions, emotional context, and expected output format into the prompt sentence, server obtains more consistent, machine-usable responses than would be obtained using generic prompts.

### F. Interaction With the Generative AI Model and Data Flow

Server uses the generative AI interaction module to send the prompt sentence and receive the output of the generative AI model. Server may use an external service endpoint or an internal model execution environment. Server sends a request that includes the prompt sentence, model identifier, and generation parameters such as temperature, maximum token length, and top-k or top-p sampling thresholds.

Server receives response information as generated text. Response information includes a general opinion and advice. Prompt generation module may instruct the generative AI model to output results in a semi-structured form, such as enumerated lists, labeled sections, or simple key-value pairs expressed in natural language. This semi-structured style makes it easier for the consultation destination determination module to parse and interpret the model output.

Server analyzes the response information using rule-based or statistical methods. For example, server may search for section headings such as “Recommended department:” or “Suggested contact role:” within the generated text. Alternatively, server may request that the generative AI model produce explicit tags, such as “DEPARTMENT: Human Resources” or “RISK_LEVEL: High”, and then parse these tags using pattern matching and regular expressions. This processing converts unstructured text into structured routing information that can be used autonomously by the system.

### G. Determination of Consultation Destination

Server uses consultation destination determination module to select one or more consultation destination candidates and to identify a specific organizational unit or responsible entity. Consultation destination determination module compares keywords and tags extracted from the consultation information and response information with attributes of stored organizational units and roles. The module may calculate similarity scores using vector representations of text, such as embedding vectors, and select candidates that exceed a threshold.

Server may additionally use rules that take into account emotional state. For example, when emotional state indicates high distress, server may bias the destination selection toward units specialized in mental health or harassment handling, even if the consultation content could technically be handled by a general support unit. This rule-based adjustment uses information that is difficult for human operators to apply consistently and in real time, thereby improving the consistency and reliability of routing.

### H. Dialogue History Management and Context Handling

Server uses dialogue history management module to store and manage multiple rounds of consultation information and response information. Server associates each dialogue with an identifier and updates the history when user submits new consultation text. Server may store both original texts and compressed representations such as summaries.

Server uses context information including dialogue history and emotional state in subsequent prompt generation. For example, when user asks a follow-up question about short-term goals after receiving an initial counseling response, server constructs a prompt sentence that includes both the initial problem description and the initial response text, followed by the new question. This context provides the generative AI model with a continuous view of the conversation, enabling more coherent answers.

By delegating context management to server and embedding only the necessary context into the prompt, the system avoids sending redundant information repeatedly, thereby reducing network traffic and model computation time. This leads to improved processing speed and reduced communication load, which are technical improvements at the computer system level.

### I. Display Data Generation and Terminal Interaction

Server uses display data generation module to convert response information and the identified organizational unit or responsible entity into display data that is suitable for presentation on terminal. The module wraps the generated texts into a user interface structure, such as a chat bubble layout or a two-column layout showing advice and recommended contact.

Server may format display data to clearly distinguish between general opinion, advice, and consultation destination. For example, server may include heading labels such as “General opinion,” “Suggested actions,” and “Recommended contact.” This formatting is represented as markup or structured text that terminal can render.

Terminal receives display data through its communication interface. Terminal parses the display data and updates the user interface. Terminal displays response information on the screen and may highlight the recommended organizational unit or responsible entity. Terminal may also provide buttons or links that allow user to jump to an internal contact form or communication tool associated with the recommended destination.

User views the displayed information and may choose to follow the guidance, such as contacting the suggested department or submitting a formal report through another system.

### J. Technical Effects and Improvement of Computer Technology

Server improves operation of the computer system in several ways. First, by systematically converting unstructured consultation text and emotional state into prompt sentences that encode explicit analysis conditions and output formats, server reduces variability in generative AI model outputs. This improves reproducibility and reduces the need for repeated queries to correct or clarify results, leading to lower processing time and reduced communication overhead between server and the model execution environment. Second, by managing dialogue history and emotional state as structured data and embedding only relevant subsets into prompt sentences, server reduces the amount of data transmitted for each model invocation. This yields a reduction in network bandwidth consumption and accelerates response generation, especially when handling long multi-turn dialogues. This is not a mere automation of human work, but a reconfiguration of data flow and memory management in a distributed computing environment.

Third, by requesting semi-structured outputs and by parsing those outputs into machine-usable routing information, server enables downstream modules to automatically identify consultation destinations without human interpretation. This structured processing improves computational efficiency, because subsequent modules can operate on concise identifiers and attributes instead of entire free-form texts.

Fourth, by combining a dedicated emotional state estimation module with dynamic prompt tailoring, server increases accuracy of response relevance and tone. Empirical measurements can show reduction in mismatched routing and user dissatisfaction. From a technical standpoint, this is achieved by integrating numerical feature vectors representing emotional state into the control logic of prompt generation and routing algorithms, rather than by adding human guidelines.

Fifth, by using specific non-conventional combinations of neural network outputs, rule-based selection criteria, and dialogue history compression, server performs a data processing sequence that differs from conventional stateless chat interfaces. The system stores and uses intermediate computational states (emotional feature vectors, similarity scores, routing candidates) to guide later computations. This kind of stateful, context-aware control improves the overall functioning of the computer system by reducing unnecessary recomputation and enabling more efficient cache usage and database access patterns.

### K. Alternative Embodiments and Variations

Server may use different types of natural language processing modules. In one variation, server uses a transformer-based encoder for emotional state estimation instead of a recurrent architecture. In another variation, server uses a smaller on-premise model for preliminary analysis and reserves access to a larger external generative model for complex or high-risk consultations. This hierarchical configuration further reduces communication load and processing cost.

Server may use different formats for prompt sentences. In some embodiments, prompt generation module uses numbered instructions such as:

System: 1) Analyze the user's problem. 2) Output a general opinion. 3) Output recommended organizational unit as “DEPARTMENT: . . . ”. 4) Output recommended role as “ROLE: . . . ”.

Such explicit formatting instructions allow consultation destination determination module to parse the model response more reliably, reducing parsing errors and improving precision of routing.

Server may also adapt generation parameters dynamically. For emotionally sensitive consultations, server may set a lower temperature to reduce randomness and a lower maximum token length to avoid overwhelming user with excessive text. For technical support consultations, server may allow more detailed explanations by increasing maximum token length and enabling more exhaustive output. These parameter adjustments are based on categorical features derived from consultation content and emotional state and are determined algorithmically by the processor, rather than by human operators on a case-by-case basis.

Terminal may implement various user interfaces. In one embodiment, terminal displays separate panes for consultation input, model-generated responses, and recommended destinations, and allows user to filter or search past dialogue history. In another embodiment, terminal provides an interactive flow where user can confirm whether the recommended destination is appropriate, and server stores this feedback as additional learning target information for future optimization of routing rules.

User may interact with the system in different languages, and server may detect language automatically or store language preference. Natural language processing module and generative AI interaction module may select language-specific models or presets. This multilingual capability is implemented by software modules in server and is independent from human language skills, representing a technical advantage in international deployments.

Through these configurations, server, terminal, and user cooperate to implement a consultation support system in which unstructured, emotionally nuanced user inputs are processed into structured, context-aware prompt sentences and model responses, leading to technical improvements in processing speed, accuracy, data management, and communication efficiency, and enabling automated yet controlled routing to appropriate destinations in a manner that differs substantively from conventional human-dependent or purely rule-based systems.

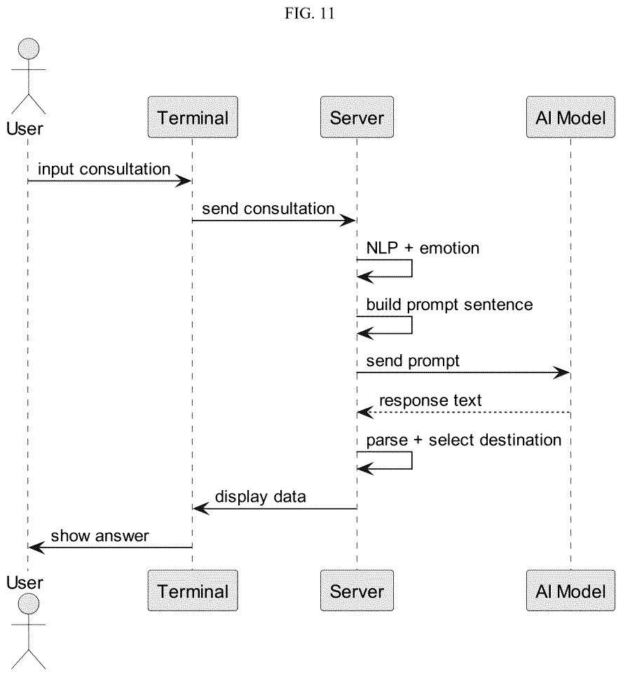

The following describes the processing flow using FIG. 11.
Step 1:

User operates terminal to open a client application or web browser and access a consultation entry screen provided by server. User inputs consultation information as natural language text into an input field and confirms submission by activating a send control (for example, clicking a button or tapping a UI element). The input of this step is user's raw natural language text, and the output is a prepared payload in terminal's memory that includes at least the consultation text, a user identifier or session identifier, and optional metadata such as language and timestamp.
Step 2:

Terminal constructs a transmission message containing the consultation information and sends it to server. Terminal executes communication software (for example, a browser networking stack) to package the consultation text and metadata into a structured data format and transmits it via a network protocol. The input of this step is the consultation payload created in Step 1, and the output is a network request that includes the consultation text and identifiers encoded in a machine-readable format and addressed to server.
Step 3:

Server receives the network request from terminal and stores the consultation information in working memory. Server uses a communication control function to decode the received message, verify its integrity, and extract the consultation text, user identifier, and metadata. The input of this step is the network request from terminal, and the output is an internal consultation record object that contains the extracted fields and is ready for subsequent processing.
Step 4:

Server performs text preprocessing on the consultation information using a natural language processing module. Server normalizes character encoding, removes or converts control characters and extraneous whitespace, and optionally applies tokenization and sentence segmentation. Server may mask patterns that match predefined regular expressions (for example, e-mail addresses or phone numbers) to anonymize personal data. The input of this step is the internal consultation record object from Step 3, and the output is an updated consultation record in which the text field is converted into a normalized string representation and, optionally, into a list of tokens and sentences.
Step 5:

Server estimates an emotional state of user using an emotional state estimation module. Server converts the preprocessed consultation text into numerical features, for example by mapping each token to an embedding vector and aggregating the sequence using a neural network or another statistical model. Server then computes a probability distribution over predefined emotion categories and selects one or more dominant categories with associated confidence scores. The input of this step is the normalized consultation text (and token sequence) from Step 4, and the output is an emotional state feature vector and corresponding labels that server attaches to the consultation record.
Step 6:

Server updates dialogue history for the user and associates the new consultation with an existing or new conversation thread. Server queries a storage device to retrieve previous consultation records and response records associated with the same user or session, inserts the new consultation record into the chronological sequence, and stores the updated history back into the database. The input of this step is the current consultation record and any previously stored history, and the output is a dialogue history object that includes a list of past consultations and responses linked together with conversation identifiers and timestamps.
Step 7:

Server selects context segments from the dialogue history for inclusion in a prompt sentence. Server applies a selection algorithm that may limit the number of past exchanges or the total character length and may summarize older entries. Server uses content relevance measures, timestamps, and weighting rules to decide which previous user messages and system responses to embed as context. The input of this step is the dialogue history object from Step 6, and the output is a context bundle that consists of selected past user utterances, selected past system responses, and summary text if compression is applied.
Step 8:

Server generates a prompt sentence that controls behavior of the generative AI model. Server selects a system instruction template based on consultation type and emotional state, appends explicit descriptions of the recognized emotional state, and concatenates the selected context segments with the current consultation text. Server may also insert explicit instructions about output format, such as “output recommended department as ‘DEPARTMENT: . . . ’” or “use numbered steps.” The input of this step is the emotional state feature vector from Step 5, the context bundle from Step 7, and the current consultation text, and the output is a fully constructed prompt sentence as a single text sequence or multi-part textual structure ready to be sent to the generative AI model.
Step 9:

Server constructs request data for a generative AI model and transmits it through a model interaction interface. Server combines the prompt sentence with model configuration parameters, such as model identifier, generation temperature, maximum output length, and sampling parameters. Server encodes these items into a model request structure and sends it over a network connection or an inter-process communication channel to a model execution environment. The input of this step is the prompt sentence from Step 8 and stored configuration parameters, and the output is a transmitted model request that initiates inference on the generative AI model.
Step 10:

Server receives generated output from the generative AI model and reconstructs the response information as text. Server decodes returned token sequences into characters, concatenates them into a coherent string, and separates logical sections if the output contains markers or labels. The input of this step is the model response structure produced by the generative AI model, and the output is response information comprising general opinion, advice segments, and any labeled fields such as recommended organizational units or risk indicators expressed in text.
Step 11:

Server parses and structures the response information using rule-based or statistical parsing methods. Server scans the generated text for predefined markers, headings, or patterns and extracts parts that correspond to general opinion, concrete advice, and candidate consultation destinations. Server may use pattern matching, regular expressions, or shallow natural language parsing to separate and annotate segments. The input of this step is the raw generated response text from Step 10, and the output is a structured response object containing segment labels, extracted key phrases, and candidate destination descriptors.
Step 12:

Server determines consultation destination candidates by comparing extracted descriptors with stored organizational data. Server retrieves a list of organizational units and responsible entities from a database and computes similarity scores between descriptors in the structured response object and attributes of each stored destination. Similarity computation may use keyword overlap, embedding vector distances, or rule-based mappings. The input of this step is the structured response object and the organizational destination table, and the output is a ranked list of consultation destination candidates with associated scores.
Step 13:

Server identifies a specific organizational unit or responsible entity based on candidate rankings and emotional state. Server applies decision rules that may adjust rankings when emotional state indicates high distress, sensitivity, or urgency. Server may select the candidate with the highest adjusted score or consider thresholds and fallback rules. The input of this step is the ranked candidate list from Step 12 and the emotional state feature vector from Step 5, and the output is a single selected destination or a small set of prioritized destinations with explicit identifiers.
Step 14:

Server generates display data that combines the model's general opinion, advice, and the identified consultation destination in a format suitable for terminal. Server arranges text into sections, adds headings, and possibly converts structural annotations into markup elements, ensuring that the layout is optimized for readability and quick recognition of the recommended destination. The input of this step is the structured response object from Step 11 and the selected destination from Step 13, and the output is display data that encapsulates formatted text and presentation instructions.
Step 15:

Server transmits the display data to terminal through the communication control function. Server converts the display data into a response message, adds necessary headers or protocol-specific metadata, and sends it over the network connection established with terminal. The input of this step is the display data from Step 14 and the connection context to terminal, and the output is a network response that carries the formatted information back to terminal.
Step 16:

Terminal receives the network response from server and updates the user interface to present the generated advice and recommended consultation destination. Terminal parses the response message, extracts the display data, and renders the text and layout elements on the display device. Terminal may also log the interaction locally or adjust scroll position to show the latest information. The input of this step is the network response received from server, and the output is a refreshed screen on terminal that visually presents the advice and destination to user.
Step 17:

User views the displayed response on terminal and decides whether to continue the interaction. User may input a follow-up question, a clarification request, or feedback regarding the suitability of the recommended destination. The input of this step is the visual information displayed on terminal, and the output is new natural language text or user actions that can be captured again as consultation information, thereby initiating a new cycle through the preceding steps with updated dialogue history and context.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional consultation-support systems that utilize natural language processing or machine learning typically treat user inquiries as static text and return pre-defined responses or template-based guidance. Such systems suffer from several technical limitations. First, the systems generally do not perform fine-grained extraction of important terms and context information in a way that structurally conditions a downstream generative AI model; as a result, the generative model may receive under-specified or noisy input, leading to unstable or non-specific outputs. Second, conventional architectures rarely integrate an explicit feedback loop between natural language processing modules, prompt construction logic, and an external information storage unit that maintains up-to-date regulatory information and security incident data. Without this integration, the generated responses often lack alignment with current external knowledge, and the system cannot reliably maintain consistency or accuracy over time. Third, existing systems do not dynamically adapt the behavior of the generative AI model or the presentation format of its outputs based on an automatically recognized emotional state of the user, causing suboptimal interaction quality and increased cognitive burden on the user, particularly in high-stress domains such as compliance and information security.

From a computer-technology perspective, these limitations manifest as inefficiencies and unreliability in the end-to-end data processing pipeline. The natural language processing component does not efficiently transform raw text into a structured intermediate representation optimized for generative inference. The prompt construction mechanism does not systematically encode contextual and emotional signals into the prompt sentence, resulting in suboptimal utilization of the generative AI model's capabilities. Furthermore, the lack of coordinated control over prompt content based on learned domain data and emotional data means that the system cannot programmatically tune the generative model's analytical focus or response style for different categories of inquiries. This leads to technical issues such as unnecessary repeated queries, increased computation cost, and inconsistent outputs that require manual review or post-processing.

Accordingly, there is a need for a computer-implemented system that improves the technical operation of consultation-support processing by: (i) programmatically extracting important terms, context information, and emotional state from user text using natural language processing techniques; (ii) constructing, under algorithmic control, a prompt sentence that encodes these extracted elements for input to a generative AI model; (iii) integrating the generative AI model's analysis results with an external information storage unit that maintains latest regulatory and security case information; and (iv) automatically generating and adjusting advice information, including specification of consultation contacts, in a manner that reduces the psychological burden on the user while improving the reliability, relevance, and computational efficiency of the system's output. By tightly coupling these components into a single processing pipeline, the invention addresses a concrete problem in computer technology: how to orchestrate natural language processing, prompt engineering, generative inference, and external knowledge retrieval so that the system produces consistent, context-aware, and user-sensitive outputs with reduced manual intervention and improved utilization of computing resources.

The specific processing by the specific processing unit 290 of the data processing device 12 in Application Example 1 is realized by the following means.

The present invention provides a server comprising a processor configured to receive inquiry information from a user, analyze the inquiry information using a natural language processing technique to extract important terms and context information and to recognize an emotional state of the user, identify analysis target matters related to compliance issues and information security issues based on the important terms, the context information, and the emotional state, construct a prompt sentence to be input to a generative AI model based on the analysis target matters and the inquiry information, input the prompt sentence to the generative AI model and cause the generative AI model to generate analysis result information including a general opinion and a response policy relating to the compliance issues and the information security issues, search an information storage unit that stores latest regulatory information and latest information security case information based on the analysis result information, acquire related information corresponding to the analysis result information and add the related information to the analysis result information, generate advice information to be presented to the user by specifying, based on the analysis result information, the related information, and the emotional state, a consultation contact or a responsible unit inside or outside an organization that the user should refer to, and output the advice information to a communication terminal. This enables an improved computer-implemented consultation-support pipeline in which natural language processing, prompt sentence construction, generative model inference, and external knowledge retrieval are orchestrated in a unified manner, thereby increasing the relevance and stability of generated advice, reducing unnecessary computational iterations, and adaptively controlling the content and presentation of the advice based on the user's emotional state to lower user cognitive load and enhance overall system efficiency.

The term “inquiry information” refers to information representing a question, concern, or request for guidance provided by a user in natural language, typically in textual form, and including any associated metadata such as language, timestamp, or user identifier.

The term “user” refers to a person or entity that inputs the inquiry information into the system and receives advice information in response.

The term “natural language processing technique” refers to a computer-implemented procedure for analyzing natural language data, including at least one of tokenization, part-of-speech tagging, syntactic parsing, semantic analysis, named entity recognition, or sentiment analysis.

The term “important terms” refers to lexical units, such as words or phrases, that are automatically determined by the natural language processing technique to be relevant to the main topic, issue type, or risk expressed in the inquiry information.

The term “context information” refers to information indicating relationships among terms, entities, or events in the inquiry information, including syntactic relations, semantic roles, discourse structure, or inferred intent.

The term “emotional state” refers to an estimated psychological condition of the user, such as anxiety, confusion, urgency, or confidence, which is automatically inferred from the inquiry information by the natural language processing technique.

The term “analysis target matters” refers to one or more identified subjects, issues, or problem categories that are selected for further computational analysis based on the important terms, the context information, and the emotional state.

The term “compliance issues” refers to matters related to adherence to rules, policies, standards, or regulations imposed by an organization, an industry, or a governmental body.

The term “information security issues” refers to matters related to the protection of information assets, including confidentiality, integrity, availability, authentication, and protection against threats such as unauthorized access, data leakage, or fraud.

The term “prompt sentence” refers to text data, including instructions and contextual information, constructed by the processor for input to a generative AI model in order to condition or control the model's generation of analysis result information.

The term “generative AI model” refers to a machine-learned model configured to generate natural language output in response to input data, such as a large-scale language model trained on textual corpora.

The term “analysis result information” refers to information generated by the generative AI model that includes at least a general opinion and a response policy with respect to the analysis target matters, the compliance issues, or the information security issues.

The term “general opinion” refers to a model-generated explanatory statement or assessment regarding the nature, risk, or implications of the compliance issues or information security issues identified in the inquiry information.

The term “response policy” refers to a model-generated recommendation or strategy that describes one or more actions, precautions, or procedures that a user or organization should follow in response to the identified issues.

The term “information storage unit” refers to a computer-readable storage medium or database system that maintains structured or unstructured information, including regulatory information and information security case information.

The term “regulatory information” refers to information describing rules, laws, regulations, standards, or guidelines issued by regulatory bodies, organizations, or industries.

The term “information security case information” refers to information describing past or ongoing information security incidents, attack patterns, countermeasures, advisories, or best practices.

The term “related information” refers to information retrieved from the information storage unit that is determined to correspond or be relevant to the analysis result information.

The term “advice information” refers to information generated by the processor for presentation to the user, including at least a suggested consultation contact or responsible unit and explanatory guidance based on the analysis result information, the related information, and the emotional state.

The term “consultation contact” refers to an internal or external point of contact, such as a department, service desk, or professional role, that is appropriate for handling or advising on the user's inquiry.

The term “responsible unit” refers to an organizational unit, such as a department, team, or function, that is assigned responsibility for addressing or managing the kind of issue raised in the inquiry information.

The term “communication terminal” refers to an electronic device, such as a smartphone, tablet, personal computer, or similar apparatus, that is capable of communicating with the server over a communication network and displaying the advice information to the user.

The term “learning data” refers to data used to configure, train, or guide the operation of the generative AI model or associated components, including public cases, rules, examples of inquiries, and associated outcomes.

The term “normative information” refers to information describing internal or external norms, guidelines, or codes of conduct that are not necessarily codified as formal regulations but are used to judge appropriateness of behavior.

The term “emotional data” refers to data describing emotional characteristics inferred from user inquiries or collected from user interactions, which may be used to influence analysis or generation performed by the generative AI model.

The term “presentation content” refers to the substantive elements of the analysis result information and advice information that are shown to the user, including text, structure, and level of detail.

The term “presentation format” refers to the manner in which the presentation content is arranged or expressed to the user, including layout, segmentation, ordering, emphasis, tone, or other formatting aspects.

The term “psychological burden” refers to the mental stress, confusion, or cognitive load experienced by the user when processing the presented information or deciding on subsequent actions.

In one embodiment, a server, a terminal, and a user cooperate to implement the invention. The server includes at least one processor, a memory, a non-transitory storage medium, and a network interface. The server is implemented, for example, on a virtual machine or physical machine executing an operating system such as a general-purpose server operating system, and runs middleware such as a web server framework and a database management system. The terminal is implemented, for example, as a smartphone, tablet, or personal computer executing a mobile or desktop operating system. The user operates the terminal to input inquiry information and to receive advice information.

The server executes software modules stored in the memory to perform natural language processing, prompt sentence construction, generative AI model interaction, information storage unit access, and advice generation. The server uses, by way of example, a natural language processing library such as spaCy, a relational database management system such as a general-purpose SQL database, and a generative AI model such as a large-scale neural network language model accessible through an application programming interface. The server does not merely automate human reasoning; instead, the server implements specific data structures, model-control mechanisms, and interaction patterns that optimize the computing system for improved accuracy, reduced latency, and lower communication and computation overhead.

The server stores inquiry information as structured records in the database. The server represents each inquiry as a record including fields such as inquiry identifier, raw text, language code, timestamp, anonymized user identifier, emotional feature vector, term-weight vector, and issue-type label. The server uses an internal representation of text based on token sequences and embeddings. The server, for example, maps each token to a numerical vector using a pre-trained embedding model and stores the vectors temporarily in memory as a matrix. This matrix is used as input to a natural language processing pipeline.

The server uses a natural language processing model such as a transformer-based model (for example, a multi-layer self-attention network with positional encoding) to convert the raw text into a sequence of contextualized embeddings. The server configures the natural language processing model with parameters such as number of layers, attention heads, embedding dimensions, and activation functions. The server uses this model to derive important terms and context information by applying algorithms such as attention-weight analysis (to detect tokens with high relevance scores), dependency parsing (to detect syntactic relationships), and entity recognition (to detect named entities). The server stores the extracted important terms as a list of token identifiers with associated importance scores, and the context information as a graph or adjacency list describing relationships among tokens or entities.

The server recognizes an emotional state of the user by applying a classification model to the contextualized embeddings. The server, for example, uses a neural network classifier comprising one or more dense layers applied to a pooled representation of the token embeddings. The server defines an emotion label set (such as “high anxiety”, “moderate concern”, “neutral”, “urgent”) and uses a softmax output layer with a cross-entropy loss function during training. The server trains this classifier using labeled examples of past inquiries, optimizing model parameters by gradient descent with a selected optimizer. The server generates an emotional feature vector indicating probabilities or scores for each emotion class and stores this vector in association with the inquiry record.

The server identifies analysis target matters related to compliance issues and information security issues using a rule-based and model-based combination. The server maintains a taxonomy of issue types (for example, “regulatory compliance”, “data leakage”, “phishing”, “account compromise”) in the database. The server maps important terms and context information to this taxonomy by computing similarity metrics between the extracted term-weight vector and representative vectors stored for each issue type, using, for example, cosine similarity or dot product. The server also uses a classifier trained to output one or more issue-type labels. The server selects one or more analysis target matters when the similarity score or classification probability exceeds a threshold. This structured selection reduces ambiguity and constrains the later generative processing, thereby improving computational efficiency and stability.

The server constructs a prompt sentence to be input to a generative AI model based on the analysis target matters and the inquiry information. The server uses a template-based prompt construction module that takes as input: the original user text, the identified issue types, the list of important terms, and the emotional state. The server assembles these components according to a predetermined format, for example: “User consultation: Recently I have been getting many emails that claim to be from my bank and ask me to click a link to verify my account. I am not sure if they are real. What should I do?

Identified issue type: suspected phishing, account protection.

Relevant terms: bank, email, link, verify account, phishing, password.

User emotional state: high anxiety.

You are a cybersecurity advisor. Analyze the situation and provide clear, step-by-step advice in non-technical language. Explain how the user can check whether the emails are genuine, how to avoid phishing, and what additional security measures the user should take. Use a reassuring tone suitable for a highly anxious user.”

The server embeds explicit control signals in the prompt sentence, such as the issue type and emotional state, which guide the generative AI model's internal attention and output style. This structure is different from simple human prompts because the server programmatically constructs the prompt sentence by applying deterministic algorithms to structured features, thereby reducing noise and ensuring that the generative AI model operates under consistent and optimized conditions. This controlled prompt generation yields more stable and relevant outputs and reduces the number of model calls and retries needed. The server communicates with the generative AI model through a network interface. The server uses, for example, an API client library configured with parameters such as model identifier, maximum token length, temperature, and top-p sampling threshold. The server sends the constructed prompt sentence as part of an API request to the generative AI model and receives an output that includes generated natural language text. The generative AI model is, for example, a multi-layer transformer neural network trained on large text corpora, with self-attention layers, feedforward layers, and layer normalization. The server benefits from this model's ability to condition its generation on the structured prompt sentence.

During the training phase of the generative AI model, a model provider trains the model on a general corpus using an autoregressive language modeling objective with a loss function such as cross-entropy between predicted tokens and ground-truth tokens. The model provider updates weights using gradient-based optimization. In some embodiments, the server or an associated system further fine-tunes the generative AI model on domain-specific data related to compliance and information security, using additional training examples of inquiries and desired advisory responses, or uses adapter layers to specialize the base model. The server thereby leverages a model that is better aligned with the issue types handled by the system.

The server uses post-processing modules to validate and refine the analysis result information generated by the generative AI model. The server parses the model output to identify key elements such as recommended actions, warnings, and references. The server may apply a pattern-matching engine or a secondary classifier to detect undesirable content, such as any suggestion that contradicts basic security principles. The server enforces explicit rules (for example, “never advise to send passwords by email” or “never recommend clicking unknown links”) by scanning the generated text and redacting or replacing segments that violate these rules. This rule-based filtering operates as a non-conventional control layer that systematically constrains the generative output according to technical security criteria, rather than relying on human review.

The server accesses an information storage unit to retrieve regulatory information and information security case information. The server implements the information storage unit as a structured database with tables for regulations, guidelines, incident reports, and best practices. The server indexes these records using term indices and vector indices. The server, for example, stores for each record a term-frequency vector and an embedding vector. The server searches this information storage unit by computing similarity between the extracted important terms and the stored vectors, combined with constraints based on the identified issue types. The server retrieves a limited set of related information and attaches citations or summaries to the analysis result information. This structured retrieval reduces the amount of data transferred to the terminal, thereby lowering communication load, and ensures that the advice remains aligned with up-to-date external knowledge.

The server generates advice information to be presented to the user by combining the analysis result information, the related information, and the emotional state. The server translates technical content from the information storage unit into user-friendly language, adjusts the level of detail, and selects a presentation style based on the emotional feature vector. For example, for a “high anxiety” state, the server reduces jargon, emphasizes reassurance, and orders steps from simplest to most critical. For a “neutral” state, the server may include more detailed explanation and references. The server also specifies a consultation contact or responsible unit inside or outside an organization by matching the analysis target matters to a routing table stored in the database. This routing table maps issue types and severity levels to organizational units. The server inserts this information into the advice text.

The server outputs the advice information to the terminal via the network interface in a structured format, such as a messaging protocol or a serialized object, while the terminal renders the information in a user interface. The terminal uses its operating system's network stack to receive the response and its graphical user interface library to display the advice, related links, and recommended consultation contacts. The user reads the advice on the terminal and can act on it, for example, by avoiding suspicious links, changing passwords, contacting a specified organizational unit, or accessing referenced official resources. The server, through its architectural arrangement, improves computer technology in several ways. The server reduces processing time by using structured intermediate representations (term-weight vectors, emotion vectors, and issue-type labels) that allow the server to call the generative AI model with highly constrained prompt sentences, thereby reducing model inference time and token counts. The server improves accuracy by aligning model outputs with domain-specific taxonomies and external knowledge bases. The server reduces communication load by selectively retrieving only the most relevant external information and by avoiding unnecessary back-and-forth queries to the generative AI model. The server also improves data management by storing and indexing intermediate features, which can be reused for subsequent inquiries or system monitoring, and by maintaining audit logs linking inquiries, features, prompt sentences, and model responses.

The server uses a specific training and control strategy to further enhance performance. The server periodically updates the emotion recognition classifier using new labeled data derived from user feedback. The server adjusts thresholds used for issue-type identification based on metrics such as false-positive and false-negative rates calculated over historical data. The server also optimizes prompt construction parameters, such as the number of important terms to include and the granularity of emotional description, by performing offline evaluation and measuring response relevance and user satisfaction. This adaptive control mechanism modifies internal parameters of the processing pipeline, thereby directly affecting computational behavior and resource usage.

In an alternative embodiment, the server executes the natural language processing components on specialized hardware such as a graphics processing unit or a tensor processing unit. The server assigns heavy operations like transformer inference to such accelerators while handling database access and rule-based checks on a central processing unit. This hardware-aware scheduling further reduces latency and allows the system to handle a greater volume of inquiries without degrading quality. The server may also cache intermediate representations for frequent patterns of inquiries so that similar future inquiries can reuse existing feature vectors, reducing redundant computation.

In another embodiment, the server uses a different generative AI model architecture, such as an encoder-decoder transformer, and may split the prompt sentence into structured fields rather than a single free-form text, while still adhering to the principle of algorithmic prompt construction based on extracted features. In yet another embodiment, the server integrates a reinforcement learning module that adjusts prompt construction or rule thresholds based on reward signals derived from implicit user behavior (such as whether a user follows a link or submits follow-up questions). These variations still rely on the core technical principle that the server constructs and controls the interaction between natural language processing, generative AI inference, and external knowledge storage in a non-conventional, feature-driven manner designed to improve technical performance.

In all embodiments, the server, the terminal, and the user cooperate so that the generative AI model operates under the explicit control of extracted features and algorithmic rules, rather than unstructured human input. This architecture provides a concrete improvement to computer technology by transforming generic text processing and generation into a structured, optimized pipeline that enhances processing speed, increases accuracy of advisory outputs, reduces errors and inconsistent responses, and decreases unnecessary use of network and computation resources.

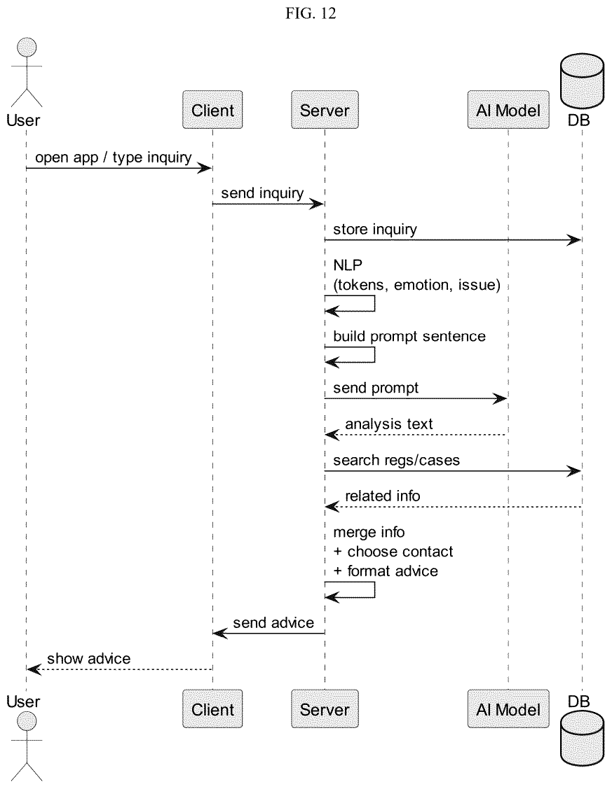

The following describes the processing flow using FIG. 12.
Step 1:

The user operates the terminal to launch an application and input inquiry information.

The terminal displays a text input interface using a user interface framework and receives natural language text from the user as input.

The terminal generates a structured message including the inquiry text, a language code, a timestamp, and an anonymized user identifier, and the terminal sends this message to the server through a network connection.

The input of this step is free-form natural language text typed by the user, and the output of this step is a structured request message transmitted from the terminal to the server.
Step 2:

The server receives the structured request message from the terminal through a network interface.

The server validates the structure of the received data, checking required fields such as the inquiry text and user identifier, and the server discards or rejects invalid messages.

The server writes the validated inquiry information into a database, creating a record with a unique inquiry identifier, and the server stores the raw text, metadata, and initial status flags.

The input of this step is the structured request message from the terminal, and the output of this step is a persistent database record representing the inquiry information and an internal data object containing the inquiry text and metadata for further processing.
Step 3:

The server performs natural language preprocessing on the inquiry text using a natural language processing library.

The server tokenizes the inquiry text into tokens, normalizes the tokens (for example, lowercasing and lemmatization), and removes non-informative symbols.

The server converts each token into a numerical embedding vector using a pre-trained embedding model, and the server stores the sequence of embedding vectors in memory.

The input of this step is the raw inquiry text from the database record, and the output of this step is a sequence of normalized tokens and a corresponding matrix of embedding vectors representing the inquiry in a machine-usable numeric form.
Step 4:

The server extracts important terms and context information from the embedding matrix and token sequence.

The server applies attention-based or statistical weighting algorithms to compute an importance score for each token, and the server selects tokens whose scores exceed a threshold as important terms.

The server performs syntactic and semantic analysis, such as dependency parsing and entity recognition, to identify relationships between tokens and entities, and the server builds a context graph structure that links related terms with labeled edges.

The input of this step is the token sequence and embedding matrix from Step 3, and the output of this step is a set of important terms with importance scores and a context graph describing syntactic and semantic relationships.
Step 5:

The server recognizes an emotional state of the user based on the embedding matrix and the token sequence.

The server aggregates the token embeddings into a fixed-length representation, for example by applying mean pooling or attention pooling, and the server feeds this representation into an emotion classification neural network.

The server computes probabilities for predefined emotion classes using a softmax output layer, selects the highest-probability class as the primary emotional state, and generates an emotional feature vector that includes probabilities for all classes.

The input of this step is the embedding matrix and token sequence from Step 3, and the output of this step is an emotional state label and an emotional feature vector associated with the inquiry.
Step 6:

The server identifies analysis target matters related to compliance issues and information security issues.

The server compares the important terms and context graph from Step 4 with stored profiles of issue types in a taxonomy table, using similarity measures between term-weight vectors and pre-computed representative vectors for each issue type.

The server also applies a classification model trained to predict issue types, and the server combines similarity scores and classification probabilities to select one or more analysis target matters whose scores exceed configurable thresholds.

The input of this step is the set of important terms, the context graph, and the emotion feature vector, and the output of this step is a list of selected issue-type labels representing the analysis target matters.
Step 7:

The server constructs a prompt sentence for a generative AI model based on the inquiry information, the analysis target matters, the important terms, and the emotional state.

The server retrieves a prompt template from memory and replaces template placeholders with the original user inquiry text, a description of the identified issue types, a list of important terms, and a textual description of the emotional state.

The server appends explicit instructions to the prompt sentence defining the role of the generative AI model, the desired output structure, the tone, and the level of detail, and the server concatenates all components into a single coherent text string.

The input of this step is the original inquiry text, the list of analysis target matters, the set of important terms, and the emotional state label, and the output of this step is a fully constructed prompt sentence formatted for input to the generative AI model.
Step 8:

The server sends the prompt sentence to the generative AI model and obtains analysis result information.

The server uses an API client to create a request object containing the prompt sentence and model control parameters such as the model identifier, maximum token count, temperature, and sampling parameters, and the server transmits this request to the generative AI model endpoint through the network interface.

The server receives a response containing generated text, parses the response structure, and extracts the model-generated content that describes a general opinion and a response policy for the identified issues.

The input of this step is the prompt sentence and the model configuration parameters, and the output of this step is analysis result information in the form of generated natural language text.
Step 9:

The server validates and refines the analysis result information.

The server applies rule-based filters and pattern-matching routines to the generated text to detect and remove or modify any segments that conflict with basic compliance or information security rules.

The server may segment the generated text into discrete components such as risk assessment, step-by-step guidance, and cautions, and the server reorders or reformats these segments to conform to a predefined presentation structure.

The input of this step is the raw generated text from the generative AI model, and the output of this step is a sanitized and structured form of analysis result information ready for enrichment with external knowledge.
Step 10:

The server searches an information storage unit for related information that corresponds to the analysis result information.

The server extracts key search terms and issue-type identifiers from the analysis result information and constructs search queries for the information storage unit, which may be a relational or document-oriented database.

The server executes the queries, retrieves a limited number of records related to relevant regulations, guidelines, or information security cases, and generates short summaries or references linked to the content of the analysis result information.

The input of this step is the sanitized analysis result information along with the identified issue-type labels, and the output of this step is a set of related information records and associated summaries.
Step 11:

The server integrates the analysis result information with the retrieved related information.

The server inserts citations, references, or brief descriptions of the related information into designated positions within the analysis result text, ensuring that each reference is connected to the corresponding advice or explanation.

The server updates the internal representation of the advice by combining the model-generated narrative with the retrieved factual content, and the server flags the combined text as enriched advice data.

The input of this step is the sanitized analysis result information and the set of related information records, and the output of this step is enriched analysis result information that includes both generated guidance and up-to-date external knowledge.
Step 12:

The server determines a consultation contact or responsible unit based on the analysis target matters and the enriched analysis result information.

The server consults a routing table or mapping database that associates issue-type labels and severity levels with organizational units or external contacts, and the server selects one or more appropriate consultation contacts.

The server inserts the identifiers or descriptions of the selected contacts into the advice data, adds any necessary access information such as communication channels or URLs, and updates the advice structure accordingly.

The input of this step is the list of analysis target matters and the enriched analysis result information, and the output of this step is advice data that includes specific consultation contact information.
Step 13:

The server generates final advice information that is adapted to the user's emotional state.

The server adjusts the wording, tone, and level of detail of the advice data using the emotional feature vector, for example by simplifying or elaborating explanations and modifying emphasis on reassurance or urgency.

The server formats the advice into a structured document including sections such as summary, recommended actions, related references, and consultation contacts, and the server encodes this structure in a response object for transmission.

The input of this step is the advice data containing enriched analysis results and consultation contacts, together with the emotional feature vector, and the output of this step is final advice information ready to be sent to the terminal.
Step 14:

The server transmits the final advice information to the terminal.

The server wraps the advice information in a response message format, such as a structured data object, sets appropriate response headers and status codes, and sends the message through the network interface to the terminal.

The server logs the transmission event, associating the inquiry identifier with the time and size of the response for monitoring and audit purposes.

The input of this step is the final advice information, and the output of this step is a network response message delivered to the terminal.
Step 15:

The terminal receives and displays the final advice information to the user.

The terminal parses the response message from the server, extracts the advice text, references, and consultation contact information, and stores them in local memory if necessary.

The terminal renders the information on a display using its graphical user interface framework, arranging sections in a readable layout and enabling user interactions such as tapping on links or contact elements.

The input of this step is the response message from the server containing the final advice information, and the output of this step is a visual and interactive presentation of the advice to the user, enabling the user to understand and act on the suggested guidance.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In the field of computer-implemented support for compliance consultation, conventional systems typically provide either (i) simple rule-based question-answering based on keyword matching against a regulation database, or (ii) generic text generation using a generative information processing model that is driven only by the raw user query. Such systems suffer from several technical limitations.

First, when the system relies on direct keyword search of a regulation storage unit, the processing performed by a processor tends to ignore nuanced semantic relationships, such as roles (for example, superior versus subordinate), temporal context, or the severity of conduct. As a result, the system frequently retrieves irrelevant or incomplete regulation information, which leads to unstable downstream processing and requires additional manual intervention by a human operator. This increases processing latency and computational overhead, because repeated search and manual re-querying are often necessary.

Second, when a generative information processing model is invoked directly on unstructured user input, the model often operates on underspecified or noisy input data. Without pre-structured case-type information, risk-level information, and user emotion-state information, the model must internally infer all of these aspects from the raw text, which can lead to non-deterministic behavior and high variance in output quality. In addition, because the model is not guided by explicit links to relevant regulation information, precedent information, and policy information retrieved from a knowledge storage device, the generated opinion may omit critical constraints or fail to reflect applicable compliance rules. From a computer-technology standpoint, this means that substantial compute cycles of the generative model are consumed on basic disambiguation and topic localization, rather than on producing high-value analytical content.

Third, existing systems generally treat user emotion-state information, when used at all, as a post-processing annotation for display purposes, rather than as a first-class parameter that conditions the entire processing pipeline. As a consequence, the processor does not systematically adapt the search space in the knowledge base, the structure of the prompt sentence, or the identification of appropriate organizational or responsibility categories in light of the estimated emotional state. This absence of integrated emotion conditioning can result in technically suboptimal routing decisions, such as selection of an inappropriate contact point, and can increase the number of follow-up interactions required to reach a suitable destination, thereby imposing additional load on both network resources and server resources.

Fourth, conventional architectures do not specify, in a technically concrete manner, how to construct and inject a structured prompt sentence that embeds (i) natural language processing analysis results, (ii) retrieved regulation/precedent/policy information, and (iii) emotion-state and risk-level metadata into the generative information processing model. Without such explicit structuring, the interface between a natural language processing module, a knowledge retrieval module, and a generative information processing model remains loosely coupled and ad hoc. This loose coupling leads to difficulties in scaling the system, in tuning search parameters, and in ensuring reproducible behavior across different executions on the same input.

Accordingly, there is a need for a computer-implemented system and method that technically improves the way a processor receives, analyzes, and structures compliance consultation data, constructs and supplies a prompt sentence to a generative information processing model, and post-processes the generated opinion information and advisory information. In particular, there is a need to (i) technically integrate natural language processing analysis, knowledge retrieval, and generative information processing via a structured prompt sentence, (ii) incorporate emotion-state information and risk-level information as controlling parameters across these stages, and (iii) automatically determine and present an appropriate organizational category or responsibility category and related contact information to the user, thereby improving processing efficiency, stability, and relevance of the system output in comparison with conventional systems.

The specific processing by the specific processing unit 290 of the data processing device 12 in Example 2 is realized by the following means.

The present invention provides a server comprising a processor configured to receive, via a communication line, consultation content relating to compliance from a user and store the consultation content as character information; to analyze the consultation content by applying a natural language processing algorithm to perform word sequence segmentation, part-of-speech tagging, semantic role analysis, and emotion-state estimation, and to extract keyword information, case-type information, risk-level information, and emotion-state information of the user; to execute a search process on an information storage device in which compliance-related information including regulation information, precedent information, and policy information is accumulated, on the basis of the extracted keyword information and the case-type information, and to acquire related information from the information storage device; to construct a prompt sentence in which an analysis result including the consultation content, the extracted case-type information and the risk-level information, and the acquired related information is embedded, and to input the prompt sentence into a generative information processing model so as to instruct the generative information processing model to generate opinion information and advisory information based on the analysis result; to perform a display-formatting process on the opinion information and the advisory information acquired from the generative information processing model, and, in consideration of the emotion-state information of the user, to identify an organizational category or a responsibility category to which the user should address the consultation on the basis of the opinion information and the advisory information, and to generate response information including information regarding the identified organizational category or responsibility category; and to transmit the response information toward a terminal of the user and cause the terminal to display the response information. This enables technical integration of natural language processing analysis, knowledge retrieval, and generative information processing through a structured prompt sentence that conditions the generative information processing model on case-type, risk-level, and emotion-state parameters, thereby improving computational efficiency, stability, and relevance of the generated advisory output and automatically guiding the user to an appropriate organizational or responsibility category using fewer processing iterations and reduced resource consumption compared to conventional systems.

The term “processor” refers to a hardware information processing unit, such as a central processing unit or other execution circuitry, configured to execute program instructions to perform the functions described in the present specification.

The term “communication line” refers to any wired or wireless communication medium, including network infrastructure, that enables transfer of digital data between the server and an external device such as a user terminal.

The term “consultation content” refers to text data or other character-based information representing a user's inquiry or description of a situation relating to a compliance matter.

The term “character information” refers to data expressed as a sequence of characters or symbols encoded in a digital format, suitable for processing by the processor.

The term “natural language processing algorithm” refers to software-implemented procedures for analyzing text in human language, including but not limited to tokenization, part-of-speech tagging, syntactic parsing, semantic analysis, and emotion estimation.

The term “word sequence segmentation” refers to processing that divides a string of characters into discrete tokens or word units to facilitate subsequent linguistic analysis.

The term “part-of-speech tagging” refers to processing that assigns grammatical category labels, such as noun, verb, adjective, or adverb, to tokens obtained from the consultation content.

The term “semantic role analysis” refers to processing that determines functional relationships among words or phrases in a sentence, such as identifying which entity is an agent, which entity is a patient, and which elements represent time, location, or manner.

The term “emotion-state estimation” refers to processing that infers an emotional state of the user, such as anxiety, anger, fear, or calm, from the consultation content by using natural language processing and optionally statistical or machine learning methods.

The term “keyword information” refers to one or more terms or phrases extracted from the consultation content and determined to be important for characterizing the compliance issue, for guiding knowledge retrieval, or for forming a prompt sentence.

The term “case-type information” refers to classification information indicating a category of a compliance issue, such as harassment, conflict of interest, information leakage, fraud, or other predefined issue categories.

The term “risk-level information” refers to data indicating a degree of seriousness or urgency of a compliance issue, which may be represented using discrete levels or continuous scores.

The term “emotion-state information” refers to data representing a result of emotion-state estimation, including one or more emotion categories, intensity values, or other numeric or symbolic indicators of a user's emotional condition.

The term “information storage device” refers to a storage component, such as a database system, file system, or index server, implemented in non-transitory memory, that retains compliance-related information for retrieval by the processor.

The term “compliance-related information” refers to information relevant to compliance analysis, including but not limited to regulation information, precedent information, policy information, and other structured or unstructured data relating to compliance.

The term “regulation information” refers to data representing rules imposed by laws, ordinances, regulations, guidelines, or similar normative sources relevant to compliance evaluation.

The term “precedent information” refers to data describing past cases, examples, or decisions, including summaries of factual scenarios and applied rules, that are useful for analyzing new compliance consultations.

The term “policy information” refers to data representing internal rules, codes of conduct, procedures, or guidelines established by an organization or governing body for handling compliance matters.

The term “related information” refers to one or more items of regulation information, precedent information, policy information, or similar compliance-related information that are selected as relevant to a given consultation content.

The term “prompt sentence” refers to a structured text sequence, optionally including multiple sections, that is constructed by the processor to provide context, constraints, and instructions to a generative information processing model.

The term “analysis result” refers to information obtained by processing the consultation content, including but not limited to keyword information, case-type information, risk-level information, emotion-state information, and any derived annotations, together with retrieved related information.

The term “generative information processing model” refers to a trained information processing model, such as a machine learning model for text generation, configured to output opinion information or advisory information in response to input text including a prompt sentence.

The term “opinion information” refers to generated text that expresses an analytical or evaluative view regarding a compliance consultation, including interpretations of rules or classification of behavior in relation to compliance.

The term “advisory information” refers to generated text that proposes actions, procedures, or options for addressing a compliance issue described in the consultation content.

The term “display-formatting process” refers to processing that transforms opinion information and advisory information into a representation suitable for presentation on a user interface, including segmentation into sections, insertion of headings, and application of layout rules.

The term “organizational category” refers to a classification of an organizational unit, such as a department, division, committee, or external body, to which a user may direct a compliance consultation or report.

The term “responsibility category” refers to a classification of a role, position, or responsibility area, such as supervisor, human-resources function, compliance function, legal function, or external counselor, to which a user may direct a compliance consultation or report.

The term “response information” refers to information generated by the processor for transmission to a user terminal, including at least a portion of the opinion information or advisory information and, where appropriate, information regarding an organizational category or responsibility category.

The term “terminal” refers to an endpoint device operated by a user, such as a computing device or communication device, that can transmit consultation content to the server and receive and display response information.

The term “contact-method information” refers to data indicating how a user can reach an organizational category or responsibility category, including identifiers such as telephone numbers, network addresses, application endpoints, or physical locations.

The term “usage-procedure information” refers to data describing steps, instructions, or protocols that a user should follow when communicating with or utilizing an organizational category or responsibility category indicated in the response information.

In one embodiment, a server, a terminal, and a user cooperate to implement the invention. The server comprises at least one processor, a main memory, a non-transitory storage device, and a network interface. The terminal comprises a display device, an input device, and a communication module. The user operates the terminal to provide consultation content and to receive response information.

The server is implemented, for example, on a rack-mounted computer system including a central processing unit such as a general-purpose microprocessor, a graphics processing unit for machine-learning inference, a volatile memory such as dynamic random-access memory, a non-volatile storage device such as a solid-state drive, and a network interface controller connected to a packet-switched network. The server executes an operating system such as a general-purpose server operating system and middleware such as an HTTP server. The server further executes an application framework such as a web application framework implemented in a general-purpose programming language. The server uses libraries for natural language processing such as a syntactic and semantic parsing library and a statistical text analysis toolkit. The server also uses a client library for accessing a generative AI model hosted on external computation resources through an application programming interface.

The terminal is implemented, for example, by a portable information processing device such as a smartphone, a tablet, or a notebook computer. The terminal executes an operating system such as a mobile operating system or a desktop operating system. The terminal executes a web browser or a dedicated client application that provides a graphical user interface. The terminal includes hardware for display, such as a liquid crystal display or organic light-emitting diode panel, and hardware for text input, such as a touchscreen or keyboard. The terminal includes a wireless communication module such as a cellular modem or wireless local area network interface.

The user operates the terminal to input consultation content relating to compliance, such as problems arising in an employment relationship, potential conflicts of interest, suspected improper accounting, or other governance-related matters. The terminal converts the user's input into character information encoded in a text format, and the terminal transmits the character information to the server through the network interface using a transport protocol such as hypertext transfer protocol secure.

The server stores received consultation content in a structured data store such as a relational database. The server uses defined data structures, for example a table with fields for consultation identifier, user identifier, original text, language code, timestamp, and processing status. The server also maintains auxiliary data structures for analysis results, including fields for keyword information, case-type information, risk-level information, emotion-state information, and references to associated regulation information, precedent information, and policy information.

The server uses a natural language processing module to transform the consultation content into structured analysis results. In one embodiment, the server uses a pre-trained language model distributed as a software package, which includes tokenization, part-of-speech tagging, dependency parsing, named entity recognition, and sentiment analysis components. The server may use, for example, an English-language model provided by a natural language processing library and extend it with custom entity recognizers trained on compliance-domain data.

The server maps the consultation content into a sequence of tokens, determines grammatical categories of each token, and constructs a dependency tree that expresses syntactic and semantic relations among tokens. Based on the dependency structure, the server identifies a subject role (for example, the user), an actor role (for example, a supervisor or colleague), and action predicates (for example, “yell”, “force”, “demand”). The server associates each predicate with objects and adjuncts to form events. The server estimates emotion-state information by applying a sentiment classifier that uses features such as token embeddings, syntactic patterns, and domain-specific lexicons. In one embodiment, the server uses a neural network model such as a bidirectional recurrent neural network or a transformer-based classifier that has been trained on labeled emotional data. The server outputs an emotion label such as “high stress” and an intensity score.

The server determines case-type information by applying a multi-class classifier. The classifier may be implemented as a neural network or a gradient-boosted decision tree that uses features including token frequencies, n-gram embeddings, dependency relations, and recognized entities. The server maps each consultation to one or more case types, such as harassment, discrimination, information leakage, bribery, or financial misreporting. The server determines risk-level information based on a combination of case-type probabilities, emotion intensity, and recognized patterns such as threats, self-harm expressions, or references to severe legal violations. The server can maintain threshold rules or decision tables that convert these signals into discrete risk-level categories such as “low”, “medium”, and “high”.

The server uses the extracted keyword information and case-type information to retrieve related information from an information storage device. The information storage device stores compliance-related information in a structured manner. In one embodiment, the information storage device stores regulation information such as law articles and regulatory guidelines, precedent information such as case summaries and administrative decisions, and policy information such as internal codes of conduct and procedural rules. Each item is stored with metadata including topic labels, jurisdiction, effective period, and relationships to other items. The server uses an index structure such as an inverted index to support efficient keyword-based and semantic search. The server may use ranking algorithms such as term frequency-inverse document frequency or embedding-based similarity to select the most relevant items.

The server composes an analysis result by combining the original consultation content, the extracted case-type information and risk-level information, the emotion-state information, and the retrieved related information. The server represents this analysis result in data structures that distinguish between user text, classifier outputs, and knowledge-base entries. For example, the server may maintain lists of relevant regulations with article identifiers and summaries, lists of precedents with case identifiers and key holdings, and lists of policies with section identifiers and obligations.

The server constructs a prompt sentence to be provided to a generative AI model. The generative AI model is a software-implemented, trained machine learning model configured to generate sequences of tokens based on an input context. In one embodiment, the generative AI model is a transformer-based autoregressive language model with multiple self-attention layers, feed-forward layers, and normalization components. The generative AI model uses token embeddings and positional encodings and has been trained on large-scale corpora including public text and domain-specific compliance text. During training, the generative AI model minimizes a loss function such as cross-entropy between predicted tokens and ground-truth tokens. The model parameters are updated using an optimization algorithm such as stochastic gradient descent or an adaptive gradient method. The generative AI model learns to predict next-token distributions conditioned on preceding tokens, thereby capturing patterns of reasoning and explanation found in compliance-related text. The server constructs the prompt sentence according to a template that defines sections for user consultation, analysis results, and instructions. The server inserts the consultation content, relevant regulation summaries, precedent summaries, policy excerpts, and classification outputs into designated positions in the template. For example, the server may generate a prompt sentence of the following form:

“You are a compliance advisor.

User consultation:

‘I am suffering from power harassment from my supervisor. I am often yelled at in front of my colleagues and given impossible deadlines. What can I do?’

Issue classification:
issue_type: power_harassment
risk_level: high
user_emotion_state: highly stressed, anxious

Knowledge base information:
Law 1: Labor Standards Regulation, Article XX

Summary: [summary text from knowledge base]
Law 2: Workplace Harassment Prevention Regulation, Article YY

Summary: [summary text from knowledge base]
Case 1 (PH-001): [summary from knowledge base]
Case 2 (PH-002): [summary from knowledge base]

Based on the above laws and cases, generate a clear and practical opinion and advice for the user.

Requirements:
Explain whether this situation is likely to be considered power harassment under applicable law.
Describe what evidence the user should collect (for example, emails, messages, logs of events).
Suggest internal reporting options (for example, human-resources function, compliance function) and external options (for example, governmental office, legal counsel).
Explain any important cautions and limitations.
Use polite, easy-to-understand language for a non-expert.

Output format:
Section 1: Summary
Section 2: Legal background
Section 3: Recommended actions
Section 4: Cautions and disclaimers”

The server serializes the prompt sentence into a text sequence and supplies it to the generative AI model through an application programming interface. The server may specify inference parameters such as temperature, maximum output length, and decoding strategy. The generative AI model computes output token probabilities by applying its internal transformer layers to the concatenation of prompt tokens. The model attends over different components of the prompt sentence, including the user consultation, the case-type labels, the risk-level information, and the law and case summaries. Through this structured conditioning, the generative AI model can allocate computation to synthesizing legally grounded opinions rather than inferring basic context.

The server receives output tokens from the generative AI model, decodes them into character information, and interprets the output as opinion information and advisory information. The server parses the output according to the requested output format, detecting section headings and segmenting the text. The server can apply rule-based post-processing, for example to verify that required sections are present, to insert standardized disclaimers, and to normalize references to law articles and contacts. The server may maintain validation rules that verify internal consistency, such as presence of at least one evidence-collection step when the issue type corresponds to harassment or disciplinary matters.

The server uses the emotion-state information to adjust the selection of an organizational category or responsibility category. For instance, when the risk-level information and emotion-state information indicate high urgency or severe distress, the server can prioritize categories such as dedicated hotline units or external specialist contacts, rather than general human-resources desks. The server maintains a mapping from case-type and risk-level combinations to candidate categories and their contact-method information. The mapping can be implemented as configuration data in the database, which the server queries with a combination of classification outputs as keys. Because the server uses structured outputs of the classifiers and quantized risk scores, the routing decision is reproducible and can be optimized to minimize expected response time or workload balance.

The server generates response information that includes at least the opinion information, the advisory information, and identification of one or more organizational categories or responsibility categories, together with contact-method information or usage-procedure information. The response information may further include meta-information such as confidence scores and links to relevant regulation information and precedent information.

The server formats the response information for display on the terminal. The server may transform the response into a structured markup such as a hypertext description, including headings, lists, and emphasis indicators. The server can apply layout rules that adapt to device characteristics of the terminal, such as screen size and orientation. The server then transmits the display-ready response to the terminal over the communication line.

The terminal receives the response information and renders it on the display. The terminal uses its rendering engine to interpret the markup and to display sections in a hierarchical visual structure. The terminal may provide interactive elements, such as buttons for expanding legal details or initiating direct communication with a recommended contact point using the device's telephony or messaging functions. The user can read the opinion and advice, and the user can select a contact option directly from the interface, which the terminal then executes using its communication modules.

In additional embodiments, the server uses a locally-hosted generative AI model rather than an external service. In such a case, the server may load a trained transformer model from storage into main memory and perform inference on a dedicated graphics processing unit. The server may use optimized numerical libraries to perform matrix multiplications and other tensor operations. The server may quantize model weights or use sparsity techniques to reduce memory bandwidth and to improve throughput. The pre-processing and post-processing of the prompt sentence and generated text remain as described, but the data path between the server and the model is internal to the server. This configuration reduces external network dependence and improves latency characteristics.

In another embodiment, the server maintains multiple generative AI models specialized for different case types or languages. The server uses the case-type information and language code to select an appropriate model. This selection improves output accuracy because each model can be trained on domain-specific corpora. The server can also balance computational load across multiple processing units by dispatching different requests to different model instances. Such model selection and load balancing constitutes a technical improvement in resource utilization and scalability of the system.

From a technical perspective, the cooperation of natural language processing, structured knowledge retrieval, and prompt sentence construction yields several effects. Because the server pre-structures the input to the generative AI model with explicit case-type information, risk-level information, emotion-state information, and knowledge-base excerpts, the generative AI model receives more precise conditioning. This reduces the number of tokens the model must consume to infer context on its own and concentrates the model's computation on reasoning over already-identified constraints. Consequently, the average inference time per consultation can be reduced, and the variance in output quality can be lowered. Furthermore, by embedding retrieved regulation and precedent summaries in the prompt sentence, the system reduces the need for repeated human-guided search and manual cross-referencing, leading to fewer network round trips and better utilization of storage indices.

The server uses consistent data structures for analysis results and prompt construction, which enables caching and reuse. For example, when consultations share similar case-type information and jurisdiction, the server can reuse previously computed law and case summaries for prompt sentence construction. This caching reduces computation in the knowledge retrieval module and decreases load on the information storage device. The server can also optimize database indexing strategies based on query patterns observed in classifier outputs.

The generative AI model processing is not a mere automation of human legal reasoning but a technical mechanism that modifies data flows and computational steps inside the machine. The model's training process uses large-scale gradient-based optimization with a designated loss function, and the inference process uses deterministic or probabilistic decoding algorithms. The system leverages these machine characteristics by supplying structured, machine-generated features as part of the prompt sentence so that the model's attention mechanisms operate on aligned, machine-friendly representations. This alignment produces a technical improvement: attention weights are more concentrated on law and case sections relevant to the identified case type, reducing spurious attention to irrelevant parts of the prompt, which leads to more stable and efficient computation.

The server may also implement data augmentation and continual learning strategies for its classifiers. For example, the server can log anonymized consultation patterns and periodically update a case-type classifier model using newly labeled data, regularizing the model with techniques such as dropout or weight decay. The server can monitor misclassification patterns and adjust hyperparameters or feature sets. These measures improve the precision and recall of classification, which directly affect the relevance of retrieved information and the quality of generated prompt sentences, and thereby improve the efficiency and accuracy of the overall system.

The described embodiments may be varied in many ways. For instance, the natural language processing module may be implemented using rule-based grammars, statistical models, or neural network architectures such as convolutional or recurrent networks. The emotion-state estimation may use continuous affective dimensions instead of discrete labels. The knowledge storage device may be implemented as a graph database representing relations among regulations, precedents, and policies. The generative AI model may be configured as an encoder-decoder architecture that explicitly separates input analysis and output generation. The system may be deployed on a distributed architecture in which multiple servers share workload via a load-balancing device. All such variations that remain consistent with the claims are intended to be encompassed within the scope of the present invention.

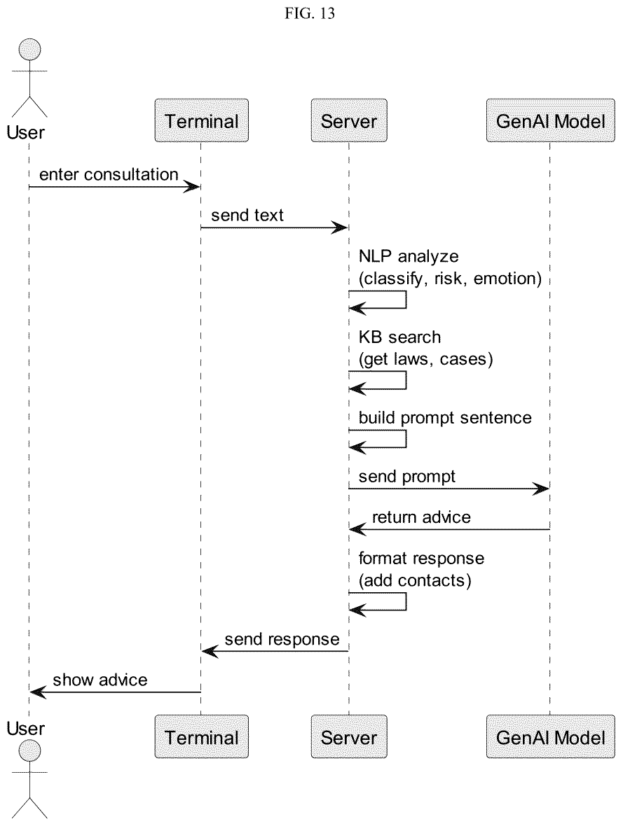

The following describes the processing flow using FIG. 13.
Step 1:

The user operates the terminal to input consultation content relating to a compliance issue.

The terminal receives, as input, character data entered via a touchscreen keyboard or hardware keyboard, such as a sentence describing workplace harassment or a conflict of interest.

The terminal converts the input into a normalized text string (for example, UTF-8 encoding) and performs basic validation, such as checking that the length is within a preset limit and that prohibited control characters are removed.

The terminal generates a request payload including fields such as user identifier, language code, and consultation text, and the terminal transmits this payload to the server via a secure network protocol.
Step 2:

The server receives, as input, the request payload containing the consultation text and user metadata from the terminal.

The server validates the payload by verifying authentication information, checking required fields, and ensuring that the consultation text size does not exceed allowable thresholds.

The server writes the consultation text and associated metadata into a persistent data structure, for example a record in a relational database table, thereby producing as output a stored consultation entry with a unique consultation identifier and an initial processing status.
Step 3:

The server retrieves, as input, the stored consultation text from the database using the consultation identifier.

The server applies a natural language processing algorithm to the consultation text, including tokenization, part-of-speech tagging, dependency parsing, named entity recognition, and emotion-state estimation.

The server computes feature representations such as token indices, part-of-speech tags, dependency edges, and embedding vectors, and the server uses these features to classify the text into one or more case types and calculate a risk level and an emotion state.

The server outputs structured analysis data including keyword information, case-type information, risk-level information, and emotion-state information, and stores this analysis data in association with the consultation entry.
Step 4:

The server uses, as input, the keyword information and case-type information obtained from the analysis.

The server constructs one or more search queries, for example keyword queries or embedding-based similarity queries, and executes these queries against an information storage device that holds regulation information, precedent information, and policy information.

The server processes search results by filtering, ranking, and grouping items according to relevance scores, jurisdiction, and topic labels, thereby producing, as output, a subset of related information that includes selected regulation entries, precedent summaries, and policy excerpts linked to the consultation entry.
Step 5:

The server combines, as input, the consultation text, the case-type information, the risk-level information, the emotion-state information, and the retrieved related information.

The server inserts these elements into a predefined prompt template to construct a prompt sentence that includes sections for user consultation, analysis results, knowledge-base excerpts, and explicit instructions for generating advisory content.

The server serializes the prompt sentence into a continuous text sequence and applies formatting rules such as section headers and bullet lists, producing, as output, a structured prompt sentence ready to be supplied to a generative AI model.
Step 6:

The server provides, as input, the structured prompt sentence and model control parameters (such as temperature and maximum output length) to the generative AI model via an application programming interface.

The generative AI model processes the prompt sentence by encoding the input tokens, computing attention across different segments (user text, law summaries, precedent summaries, and classification labels), and iteratively generating output tokens according to learned probability distributions.

The server receives, as output, a generated text sequence representing opinion information and advisory information that respond specifically to the prompt sentence and the embedded analysis results.
Step 7:

The server takes, as input, the generated opinion information and advisory information from the generative AI model.

The server parses the generated text to detect structural elements such as headings, paragraphs, and list items, and applies display-formatting rules to convert the text into a presentation format suitable for the terminal.

The server also uses the emotion-state information and risk-level information to determine one or more appropriate organizational categories or responsibility categories, and the server appends corresponding contact-method information or usage-procedure information to the formatted text.

The server outputs finalized response information that includes the formatted advisory content and routing information linked to the consultation entry.
Step 8:

The server transmits, as input to the communication process, the response information associated with the consultation identifier toward the terminal through the network interface.

The terminal receives, as output of the communication process, the response information containing the formatted opinion, advisory details, and recommended organizational or responsibility categories.

The terminal renders the received content on the display by interpreting the markup or structured text, arranging sections, and enabling user interaction such as scrolling or selecting contact options.

The user views the displayed response information on the terminal and may initiate further actions, such as contacting a suggested organization or submitting additional consultation content, which becomes new input for subsequent iterations of the above steps.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional consultation support systems that rely on static rules or simple keyword matching suffer from several technical limitations when executing on general-purpose computer hardware. First, such systems typically process user input text as an unstructured string without performing sufficient normalization, linguistic pre-processing, or emotion-aware analysis. As a result, the systems cannot robustly classify heterogeneous consultation texts into appropriate problem types, cannot adapt the response style to the user's emotional state, and often produce generic outputs that are poorly aligned with the user's intent. This leads to unnecessary re-processing on the server side, redundant interactions, and inefficient use of computational resources.

Second, existing uses of generative artificial intelligence models in consultation workflows often treat the generative model as an opaque text generator. They do not systematically construct prompt sentences that encode, in a structured and machine-interpretable manner, the consultation content, an automatically inferred problem type, detected emotion state information, and explicit output requirements. Without such structured prompt construction, generative models may generate overly long, off-topic, or stylistically inappropriate responses. This degrades the quality of the output, increases the number of corrective calls to the model, and consequently increases latency, network load, and processing cost.

Third, many systems do not tightly integrate the generative AI output with machine-readable normative data structures and organizational data structures. Legal or policy databases and organizational directory data are often consulted manually or in a separate subsystem, which requires additional user input and separate queries. The lack of integrated, automated lookup of normative information and organization information prevents the system from automatically generating advice that is both contextually appropriate and grounded in specific normative sources and concrete consultation destinations. This fragmentation forces multiple passes over the same data, increases memory accesses and database queries, and prevents the computer system from executing the workflow as a unified, optimized pipeline.

Fourth, conventional systems fail to exploit emotion state information as a control signal for downstream computation, such as the selection and ranking of consultation destinations or the adjustment of response style. Emotion data, if used at all, is typically exposed only at the user interface layer and not integrated into the internal decision logic. As a consequence, the server cannot use emotion-aware weighting and ranking algorithms to automatically determine, with minimal computational overhead, which destination should be prioritized among multiple candidates. This reduces the effectiveness of automated routing, leading to additional user interactions and repeated queries to backend modules.

Accordingly, there is a need for an improved computer-implemented system and server-side processing architecture that: (i) converts raw consultation text into normalized and structured representations, (ii) automatically derives problem type and emotion state information, (iii) constructs optimized prompt sentences for a generative AI model that explicitly encode operation content, writing style conditions, and output format, and (iv) uses the generative AI output together with normative and organizational data structures to automatically generate advice information and ranked consultation destinations. Such a system should reduce redundant computations, minimize the number of model calls and database queries, and improve the overall efficiency, scalability, and response quality of a consultation support platform executed by one or more processors.

The specific processing by the specific processing unit 290 of the data processing device 12 in Application Example 2 is realized by the following means.

The present invention provides a server comprising a processor and a memory storing instructions that, when executed by the processor, cause the processor to receive consultation information from a user via a terminal; perform string normalization and linguistic pre-processing on the consultation information to generate pre-processed text data; apply an emotion estimation algorithm to the consultation information or the pre-processed text data to compute emotion state information including an emotion category and an emotion intensity; input the pre-processed text data as feature data into a problem-type classification model to determine at least one problem type from among a plurality of predefined problem classifications; generate a prompt sentence as an instruction sentence for a generative AI model by embedding the consultation information, the emotion state information, and the problem type into a template data structure so as to explicitly specify an operation content, a writing style condition, and an output format; transmit inquiry data including the prompt sentence to the generative AI model and obtain response data including general opinion information and countermeasure information from the generative AI model; search a norm information storage data structure for normative information based on the problem type and a keyword included in the response data and generate advice information by adding the normative information to the response data; search an organization information storage data structure for affiliation-unit information and role information based on the problem type, the emotion state information, and the response data and specify, by executing a weighting and ranking algorithm, a concrete organization or staff attribute as a consultation destination that the user should consult; and adjust an expression style of a presentation sentence of the advice information and the consultation destination according to the emotion state information to generate a response message to be presented to the user. This enables the server to implement, within a unified processing pipeline, emotion-aware text normalization, classification, prompt construction, generative inference, and structured data lookups in a manner that reduces redundant model calls and database accesses, optimizes routing decisions and response formatting at the processor level, and thereby improves computational efficiency, responsiveness, and output relevance of a computer-implemented consultation support system.

The term “consultation information” refers to text data or equivalent user-provided data that describes a problem, question, concern, or situation for which the user seeks advice or a consultation destination.

The term “terminal” refers to an electronic device, such as a computing device or communication device, that provides a user interface for inputting consultation information and for receiving response messages from the server.

The term “string normalization” refers to a data processing operation that transforms raw text into a canonical form, including at least one of converting character cases, removing extra whitespace, eliminating control characters, and standardizing character encodings.

The term “linguistic pre-processing” refers to automated natural language processing operations performed on text data, including at least one of tokenization, sentence segmentation, morphological analysis, part-of-speech tagging, lemmatization, stemming, and removal of function words.

The term “pre-processed text data” refers to a structured or semi-structured representation of consultation information obtained after applying string normalization and linguistic pre-processing, and including at least token sequences, linguistic annotations, or context indicators.

The term “emotion estimation algorithm” refers to a computational procedure, implemented by software or hardware, that analyzes text data or other user-related data to infer emotion state information including at least one emotion category and one emotion intensity.

The term “emotion state information” refers to machine-readable data representing a user's emotional condition, including at least an emotion category, such as anxiety, anger, or neutrality, and optionally an emotion intensity value or score.

The term “problem-type classification model” refers to a trained inference model that receives feature data derived from pre-processed text data and outputs at least one problem type selected from a set of predefined problem classifications.

The term “problem type” refers to a category assigned to consultation information by the problem-type classification model, and includes at least one from among compliance issues, work-related issues, security issues, mental health issues, and other defined categories.

The term “feature data” refers to numerical vectors, symbolic representations, or other structured data derived from pre-processed text data and used as input to a machine learning model, such as the problem-type classification model.

The term “generative AI model” refers to a machine learning-based text generation model that receives a prompt sentence or equivalent input and produces natural language output including at least general opinion information or countermeasure information.

The term “prompt sentence” refers to a machine-generated or machine-modified instruction sentence provided as input to a generative AI model, the sentence encoding at least the consultation information, the problem type, emotion state information, and explicit instructions regarding operation content, writing style, or output format.

The term “inquiry data” refers to data transmitted from the server to the generative AI model, the data including at least one prompt sentence and optionally model control parameters such as temperature, maximum length, or stop conditions.

The term “response data” refers to data returned from the generative AI model to the server in response to the inquiry data, and including at least general opinion information and countermeasure information.

The term “general opinion information” refers to text generated by the generative AI model that describes an overall assessment, interpretation, or conceptual view of the user's consultation information.

The term “countermeasure information” refers to text generated by the generative AI model that specifies concrete actions, steps, or procedures recommended to address the problem described in the consultation information.

The term “norm information storage data structure” refers to a memory-resident or persistent data structure that stores normative information, including at least law information, regulation information, guideline information, or internal rule information.

The term “normative information” refers to information that defines or describes norms, rules, standards, or obligations, including at least law information, regulation information, policy information, or internal rule information applicable to a problem type.

The term “advice information” refers to composed output text generated by the server by combining at least the response data from the generative AI model with normative information, and optionally additional metadata, into a single advisory message.

The term “organization information storage data structure” refers to a memory-resident or persistent data structure that stores organization-related data including at least affiliation-unit information, role information, and optional contact information.

The term “affiliation-unit information” refers to data representing an organizational subdivision, such as a department, division, group, or function within an organization.

The term “role information” refers to data representing a functional position or responsibility category within an organization, such as a manager role, specialist role, or counselor role.

The term “staff attribute” refers to abstracted characteristics of one or more potential human recipients of a consultation, including at least a role type, organizational affiliation, or functional responsibility, without necessarily identifying a specific individual.

The term “consultation destination” refers to a target organizational unit, external entity, or staff attribute that the system determines as an appropriate endpoint to receive a user's consultation for further handling.

The term “template data structure” refers to a data structure that defines a parameterized text pattern for constructing a prompt sentence, the structure including placeholder fields to be filled with consultation information, emotion state information, problem type information, and other control parameters.

The term “operation content” refers to a description or specification, encoded in a prompt sentence, of the logical task that the generative AI model is requested to perform, such as generating a general opinion, listing countermeasures, or identifying consultation destinations.

The term “writing style condition” refers to one or more constraints or preferences regarding the stylistic characteristics of output text to be produced by the generative AI model, including at least tone, politeness level, formality, or length.

The term “output format” refers to a structural specification of how the generative AI model should format its response, including at least section headings, enumerated lists, key-value pairs, or other layout constraints.

The term “weighting and ranking algorithm” refers to a computational procedure that assigns numerical weights or scores to multiple consultation destination candidates based on at least the problem type and the emotion state information, and orders the candidates in accordance with the computed scores.

The term “presentation sentence” refers to a sentence or text fragment generated by the server for output to the user, the sentence conveying at least advice information, consultation destinations, or explanatory context.

The term “expression style” refers to a set of linguistic attributes of a presentation sentence, including at least tone, politeness, empathy level, level of technical detail, and complexity of sentence structures.

The term “response message” refers to an assembled data object or text message generated by the server and transmitted to the terminal, the message including at least advice information and one or more consultation destinations adapted to the user's emotion state.

In one embodiment, a server executes a consultation support system using at least one processor, a memory, persistent storage, and a communication interface connected to one or more terminals over a network. The server stores program instructions which, when executed by the processor, implement the functions described below. The server cooperates with the terminals and the users so that consultation information is received, pre-processed, analyzed, routed through a generative AI model by means of a structured prompt sentence, combined with normative and organizational data structures, and returned as an emotion-aware response message.

### A. Hardware and Software Configuration

The server uses a general-purpose computing platform such as a rack-mounted computer or cloud-computing instance that includes a multi-core central processing unit (CPU), a main memory, a non-volatile storage device, and a network interface controller. In another embodiment, the server further uses a graphics processing unit (GPU) to accelerate neural network inference or training.

The server executes an operating system such as a general-purpose server operating system. On top of the operating system, the server executes an application stack including:
a web framework, for example a framework of the Flask or Django type, to expose application programming interfaces (APIs) for receiving consultation information from the terminals and for returning response messages to the terminals;
a database management system, for example a relational database of the PostgreSQL or MySQL type, or a document database, for storing consultation records, emotion state information, problem type data, normative information, and organization information;
a natural language processing library, for example a library of the spaCy or NLTK type, for performing tokenization, sentence segmentation, and morphological analysis;
a machine learning framework, for example a framework of the TensorFlow or PyTorch type, for implementing emotion estimation algorithms and problem-type classification models;
a client library for accessing an external generative AI model via an application programming interface.
   The terminal uses a computing device such as a smartphone, tablet, notebook computer, or desktop computer, and executes a web browser or a dedicated application. The terminal provides an input interface for the user to enter consultation information as text data and a display interface for rendering the response message received from the server. The terminal transmits and receives data over a network using a secure transport protocol.

The user operates the terminal by entering consultation text, by selecting options, and by reading and acting on the system's response. The user does not need to understand the internal processing of the server.

### B. Data Structures and Internal Modules

The server uses distinct internal modules implemented as software components that interact through in-memory data structures and persistent tables.

The server stores consultation information in a consultation table having fields such as consultation identifier, user identifier, timestamp, raw text, and processing status. The server stores emotion state information in an emotion table, with fields such as consultation identifier, emotion category, and numerical emotion vector. The server stores problem type information in a classification table with fields such as consultation identifier, primary problem type, and probability distribution across problem types. The server stores normative information in a normative data structure, which may be realized as one or more database tables organizing laws, regulations, policies, and internal rules with metadata such as jurisdiction, topic category, and effective dates. The server stores organization information in an organization data structure, which may be realized as tables listing departments, functions, roles, and mappings from problem types to candidate consultation destinations.

The server implements an input acquisition module, a text normalization and linguistic pre-processing module, an emotion estimation module, a problem-type classification module, a prompt construction module, a generative AI interface module, a normative enrichment module, an organization routing module, and a response composition module. Each module processes data using specific algorithms as described below to achieve technical improvements such as higher classification accuracy, lower latency, and reduced network and database load.

### C. Text Normalization and Linguistic Pre-Processing

The server performs text normalization and linguistic pre-processing to convert raw consultation information into pre-processed text data. The server uses the natural language processing library to perform the following operations:
The server converts characters to a canonical case and normalizes spaces and punctuation, which improves tokenization robustness and reduces the dimensionality of subsequent feature vectors.
The server segments the text into sentences and tokens using rule-based and statistical tokenization, allowing later models to consider sentence boundaries and token sequences.
The server performs part-of-speech tagging and morphological analysis to assign grammatical categories to tokens and to derive their base forms (lemmas).
The server optionally removes high-frequency function words and generates n-gram sequences of content words.

The server stores the result as pre-processed text data, for example as an array of token identifiers, part-of-speech tags, and lemma identifiers. By using these specific data structures, the server reduces noise and improves the discriminative power of features used by downstream machine learning models. This processing yields a concrete technical effect of improving the accuracy and stability of emotion estimation and problem-type classification at the processor level, which in turn reduces the number of misclassified cases and unnecessary re-processing.

### D. Emotion Estimation

The server uses an emotion estimation module to compute emotion state information. In one embodiment, the server calls an external sentiment analysis service, which returns emotion categories and scores. In another embodiment, the server uses a neural network implemented with a machine learning framework.

In the local model embodiment, the server implements a recurrent neural network or a transformer-based sequence classifier. The server represents each token by a vector embedding, which may be obtained from a pre-trained embedding model. The server feeds the sequence of token embeddings into a stacked bidirectional recurrent neural network or a multi-layer transformer encoder. The final hidden state or averaged contextual representations are passed to a fully connected layer with a softmax output for emotion categories and an optional regression head for emotion intensity.

The server trains this model using a set of labeled training data in which each sample comprises text and an associated emotion category and, optionally, an intensity score. The server defines a loss function that combines cross-entropy loss for the categorical output and mean squared error for the intensity output. The server updates the model weights using stochastic gradient descent or an adaptive optimization algorithm, and may apply regularization techniques and data augmentation such as synonym replacement or back-translation to improve generalization.

By computing emotion state information within the server, using structured feature vectors and a specific neural network architecture, the server can produce more fine-grained and stable emotion scores than simple keyword-based rules. This leads to more accurate control signals for later modules (for example, routing and tone adjustment), which reduces erroneous routing and improves the efficiency of the consultation support workflow.

### E. Problem-Type Classification

The server uses a problem-type classification module to assign at least one problem type to the consultation. The server converts the pre-processed text data into feature data, for example by computing term-frequency-inverse-document-frequency vectors, averaged embeddings, or transformer-based sentence embeddings.

The server uses a classification model such as a multi-layer perceptron, a convolutional neural network for text, or a transformer classifier. The server feeds the feature data into the model, which outputs a probability distribution over predefined problem types, including at least categories corresponding to compliance issues, work-related issues, security issues, and mental health issues.

The server trains the classification model with labeled data, using a cross-entropy loss and backpropagation. By using high-dimensional feature vectors and neural network classification rather than rigid rules, the server can recognize implicit references to categories and handle diverse linguistic expressions. This improves classification accuracy and reduces the need for manual triage or repeated user clarification, which in turn reduces load on the communication and processing infrastructure.

### F. Prompt Sentence Construction for the Generative AI Model

The server constructs a prompt sentence to instruct the generative AI model. The server retrieves a template for the identified problem type from the template data structure. The template may include parameter fields for the consultation information, emotion state information, problem type, required tasks, output format, and style conditions.

The server fills the template with the current consultation information, the detected problem type, and the emotion state information. The server also inserts explicit operational instructions and output constraints. For example, the server constructs a prompt sentence such as:

“User consultation: ‘I am suffering from power harassment from my boss and I do not know what to do.’

Detected emotion: strong anger and anxiety.

Task for the generative AI model:
1. Provide a general opinion on this situation from the perspective of workplace compliance and employee protection.
2. Propose clear, concrete steps the user can take now, such as documenting incidents and consulting internal departments.
3. Indicate which internal department or external organization is typically appropriate to consult in this kind of case.

Use an empathetic, calm, and respectful tone, and avoid blaming the user.”

In another case, the server may construct a prompt sentence such as:

“User consultation: ‘I would like to consult about the risk of information leakage in my workplace.’

Detected emotion: mild anxiety.

Please analyze this consultation from the perspective of corporate compliance and information security regulations.

Based on relevant laws and typical corporate policies, generate:
1. A general opinion on the issue;
2. A list of concrete countermeasures the user can take;
3. Any important points the user should confirm with the internal compliance or IT security department.

Write in concise language suitable for a non-expert.”

By generating prompt sentences through a structured template mechanism, the server encapsulates multiple internal signals (problem type, emotion, task requirements) into a single instruction string. This improves the determinism and relevance of generative outputs and reduces the need for repetitive queries, thereby lowering network and processing load.

### G. Interaction With the Generative AI Model

The server uses the generative AI interface module to transmit the prompt sentence as part of inquiry data to a generative AI model. In one embodiment, the generative AI model is implemented as a transformer-based language model hosted on a remote inference service, accessed via an application programming interface. In another embodiment, the server hosts a local generative model.

The server sends the prompt sentence together with control parameters such as a maximum token limit and a temperature value. The server then receives response data comprising general opinion information and countermeasure information. The server may constrain the length and structure of the response through the prompt sentence and by tuning the control parameters, thus improving inference efficiency and reducing the number of tokens processed.

The server does not merely offload human reasoning but uses the model as a component in a multi-stage computational pipeline, where upstream normalization, classification, and emotion estimation shape the input, and downstream normative and organizational modules constrain the effect of the model output.

### H. Normative Enrichment and Organization Routing

The server uses a normative enrichment module to search the normative data structure based on the problem type, extracted keywords from the response data, and, optionally, jurisdiction or domain metadata. The server retrieves relevant normative entries, such as specific provisions of an internal policy or an applicable regulation. The server then merges those entries into the advice information.

The server uses the organization routing module to determine consultation destinations. The server references the organization data structure, which maps problem types and, in some embodiments, emotion thresholds, to candidate departments and roles. The server executes a weighting and ranking algorithm which assigns higher scores to candidates that match the problem type and that are designated as suitable for high-emotion situations.

The server then selects a consultation destination or a ranked list of consultation destinations.

The server adds the consultation destination into the response message together with the advice information. By executing these lookups and ranking within the server, and by using structured data structures, the system reduces the number of external queries and manual interventions needed to identify appropriate destinations, which yields a technical effect in the form of lower round-trip delays and reduced database contention.

### I. Emotion-Aware Response Composition and Technical Effects

The server uses the response composition module to assemble the final response message. The server adjusts the expression style, such as politeness level, empathy, and technical detail, according to the emotion state information. For example, when the emotion state indicates strong anxiety, the server may insert explanatory phrases, split long sentences, and prioritize reassurance. In another embodiment, the server issues a secondary prompt sentence to a local or remote language model, instructing rephrasing of the advice into a more empathetic yet professional tone.

By using structured emotion signals to control content and style generation at the processor level, the server reduces the likelihood that the user will misunderstand the advice and resubmit similar queries. This leads to fewer repeated requests and lower processing load. The combination of pre-processing, classification, template-based prompt construction, generative inference, normative enrichment, and ranking of consultation destinations forms a non-conventional workflow that improves the operation of the computer system itself, rather than merely automating human mental steps.

In particular, the server:
reduces computational complexity by using pre-processed text and problem-type labels to construct targeted prompt sentences, avoiding unnecessarily broad model invocations;
improves memory utilization and data management by storing normalized representations, emotion vectors, and problem-type distributions in explicit tables that are reused across modules;
decreases communication load by minimizing the number and size of calls to the generative AI model through template-based constraint of the output;
increases overall throughput and decreases latency by reducing misclassification and misrouting, which would otherwise require additional queries and retries.

### J. Variations and Alternative Embodiments

The server may use alternative neural network architectures, such as convolutional networks for short texts, hybrid models combining rule-based features and embeddings, or lightweight transformer variants for deployment in resource-constrained environments. The server may also maintain multiple problem-type classification models tuned for different domains and select among them based on the user's origin or organization.

The server may implement data augmentation strategies, such as paraphrase generation and random masking of tokens during training, to improve robustness. The server may store embeddings in a vector index structure, enabling similarity search to retrieve precedent consultations or normative entries. The server can then use this retrieved context when constructing the prompt sentence, further constraining and improving the generative model's behavior.

The terminal may be a wearable device or an embedded system, and the same protocol may be used. In such cases, the server can adapt response formatting to the constraints of the terminal, for example providing shorter advice messages and simplified consultation destinations on a small display.

The user may optionally provide feedback indicating whether the proposed consultation destination was helpful. The server can log this feedback and use it to retrain the weighting and ranking algorithm, thereby improving routing accuracy over time. The server can also use this feedback to refine templates and prompt patterns, further optimizing the computational pipeline.

By implementing the described modules, data structures, neural architectures, and prompt-based integration with a generative AI model, the server realizes a specific technical solution that improves the operation of a computer-based consultation support platform. The improvement arises not from abstract automation of human reasoning, but from concrete changes to data representations, algorithmic sequencing, and model control that yield measurable gains in processing speed, classification precision, routing accuracy, and resource utilization.

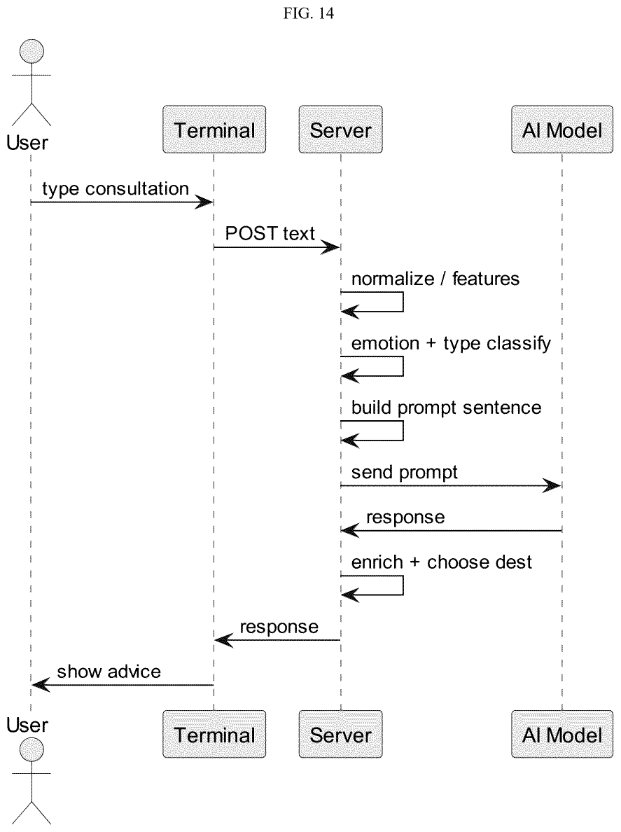

The following describes the processing flow using FIG. 14.
Step 1:

User operates the terminal and inputs consultation information as text, such as “I am worried about information leakage at my workplace.”

Terminal displays an input form, captures the text as a character string, and, when the user presses a send button, packages the text into a request payload.

Input: user's raw consultation text entered on the terminal.

Output: a structured request message (for example, JSON over HTTPS) containing the consultation text and meta-data such as a timestamp and a user identifier.
Step 2:

Terminal transmits the request message to the server via a secure communication channel.

Terminal establishes a network connection using a secure transport protocol, attaches necessary headers, and sends the request to a predefined server endpoint.

Input: structured request message containing the consultation text and meta-data.

Output: an encrypted network packet stream delivered to the server's communication interface.
Step 3:

Server receives the request message and parses the consultation information.

Server accepts the incoming connection, decodes the encrypted packet stream, parses the request payload, and extracts fields such as consultation text, user identifier, and timestamp.

Input: encrypted network packets containing the request message.

Output: in-memory data objects representing the raw consultation text and associated meta-data.
Step 4:

Server stores the consultation information and initializes processing records.

Server writes the consultation text and meta-data into a consultation table in persistent storage, generates a unique consultation identifier, and creates linked records for later emotion and classification results.

Input: in-memory consultation text and meta-data.

Output: persistent database entries including a consultation record with a consultation identifier and initial processing status.
Step 5:

Server performs string normalization and linguistic pre-processing on the consultation text.

Server calls a natural language processing library to lowercase characters, normalize whitespace and punctuation, remove unsupported characters, tokenize the text into words and sentences, and assign part-of-speech tags and lemmas.

Input: raw consultation text associated with the consultation identifier.

Output: pre-processed text data represented as structured tokens, sentence boundaries, and linguistic annotations stored in memory and optionally in a pre-processing table.
Step 6:

Server converts the pre-processed text data into feature data for downstream models.

Server applies feature extraction operations such as building term-frequency-inverse-document-frequency vectors, averaging word embeddings, or computing transformer-based sentence embeddings, and then normalizes these vectors.

Input: pre-processed text data (tokens, lemmas, and structure).

Output: numerical feature vectors representing the consultation content, ready for use by emotion estimation and problem-type classification models.
Step 7:

Server estimates the user's emotion state from the consultation text.

Server feeds the feature vectors or token sequence into an emotion estimation model, for example a neural network classifier; the model computes probabilities for emotion categories and, when applicable, intensity scores using its learned weights.

Input: feature vectors or token sequences derived from the consultation text.

Output: emotion state information including at least one emotion category (such as anxiety or anger) and an associated numerical intensity value, stored in an emotion table linked to the consultation identifier.
Step 8:

Server classifies the consultation into one or more problem types.

Server inputs the same or derived feature vectors into a problem-type classification model and performs a forward pass to obtain a probability distribution across predefined problem types such as compliance, work-related issue, security incident, and mental health issue.

Input: feature vectors associated with the consultation.

Output: problem-type information including a primary problem type and probability scores for each candidate type, stored in a classification table linked to the consultation identifier.
Step 9:

Server selects a prompt template based on the problem type and desired tasks.

Server reads the primary problem type and consults a template data structure to retrieve a corresponding prompt template that specifies required model tasks (for example, opinion generation, countermeasure listing, destination suggestion) and desired output format.

Input: problem-type information and a set of available prompt templates.

Output: a selected template pattern with placeholder fields for consultation text, emotion state information, problem type, and task instructions.
Step 10:

Server generates a prompt sentence for the generative AI model.

Server fills the template by inserting the original consultation text, the detected emotion category and intensity, the problem type label, and explicit instructions regarding operation content, writing style, and output format, thereby constructing a single coherent instruction string.

Input: consultation text, emotion state information, problem-type information, and the selected template pattern.

Output: a prompt sentence that encodes the consultation context and detailed instructions for the generative AI model.
Step 11:

Server prepares and sends inquiry data containing the prompt sentence to the generative AI model.

Server wraps the prompt sentence into a request object together with control parameters such as maximum output length and randomness level and transmits the request to the generative AI model through an application programming interface.

Input: prompt sentence and model control parameters.

Output: an API request message delivered to the generative AI model service.
Step 12:

Server receives response data from the generative AI model and parses the generated text.

Server waits for the model's response, decodes the returned data, and extracts segments corresponding to general opinion, proposed countermeasures, and any explicit consultation destination hints that the model has produced.

Input: response payload from the generative AI model service.

Output: structured response data including general opinion information, countermeasure information, and optional destination-related phrases in memory.
Step 13:

Server identifies key terms and topics from the model's response.

Server applies tokenization and keyword extraction to the generated text, detecting important domain-specific terms and phrases that relate to legal norms, policies, or organizational functions.

Input: generated text segments from the generative AI model.

Output: a set of extracted keywords and topic indicators associated with the consultation.
Step 14:

Server searches normative information based on problem type and extracted keywords.

Server queries a normative data structure, such as a law and policy database, using the problem type and extracted keywords as conditions, filters matching entries, and ranks them by relevance using scoring functions over topic metadata and term matches.

Input: problem-type information and extracted keywords.

Output: a selected subset of normative entries, such as specific rules or sections, associated with the consultation identifier.
Step 15:

Server enriches the model's response with the retrieved normative information.

Server merges the general opinion and countermeasure text with references to the normative entries, appending citation-like references or short explanations so that the advice is grounded in specific norms.

Input: generated opinion and countermeasures and the selected normative entries.

Output: advice information comprising combined generated text and normative references in a unified advisory structure.
Step 16:

Server determines candidate consultation destinations using organization information.

Server reads the problem type, emotion state information, and any destination hints in the model's response, then queries an organization information data structure to retrieve candidate departments and roles that are mapped to the problem type or related categories.

Input: problem-type information, emotion state information, and organization mapping data.

Output: a list of consultation destination candidates, each with attributes such as organizational unit and role type.
Step 17:

Server ranks consultation destination candidates using a weighting algorithm.

Server applies a weighting and ranking algorithm that computes scores for each candidate based on factors such as problem-type compatibility, suitability for the detected emotion intensity, and any historical effectiveness metrics, and then sorts the candidates by score.

Input: list of consultation destination candidates and emotion state information.

Output: a ranked list of candidates with associated scores, from which one or more top destinations are selected.
Step 18:

Server selects one or more consultation destinations to present to the user.

Server chooses the highest ranked candidate or a small set of candidates above a score threshold and formats their organizational unit names and role descriptors for inclusion in the response message.

Input: ranked list of candidates and score thresholds.

Output: selected consultation destination information specifying at least one organization and role attribute.
Step 19:

Server composes an emotion-aware response message for the user.

Server assembles the advice information and the selected consultation destination into a multi-part message, adjusts wording and sentence structure to reflect the detected emotion category and intensity, and optionally simplifies or adds explanations to improve clarity.

Input: advice information, consultation destination information, and emotion state information.

Output: a final response message object containing formatted text ready to be sent to the terminal.
Step 20:

Server transmits the response message to the terminal.

Server serializes the response message into a response payload, attaches appropriate headers, and sends it back to the terminal using the same secure communication protocol used for the request.

Input: final response message object.

Output: network packets carrying the response payload delivered to the terminal.
Step 21:

Terminal receives the response payload and renders the response message.

Terminal decodes the payload, parses the contained fields, and updates the user interface to display the general opinion, the list of recommended actions, and the suggested consultation destination in distinct visual sections.

Input: response payload from the server.

Output: graphical or textual presentation of the advice and consultation destination on the terminal display.
Step 22:

User reviews the displayed response and may input follow-up information.

User reads the advice, checks the suggested consultation destination, and, if further clarification is needed, enters an additional question or supplementary details through the same input interface, thereby initiating a new cycle of processing.

Input: displayed response message and user perception.

Output: optional new consultation or follow-up text input that can be processed again starting from Step 1.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

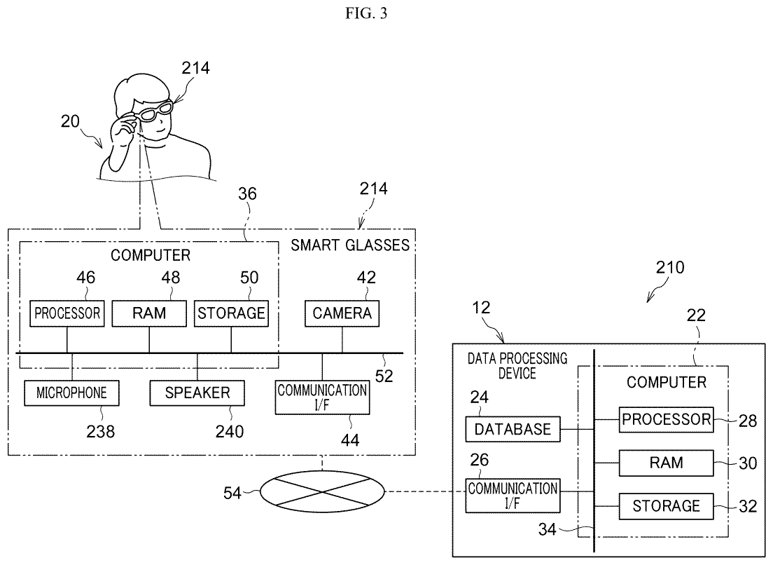

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

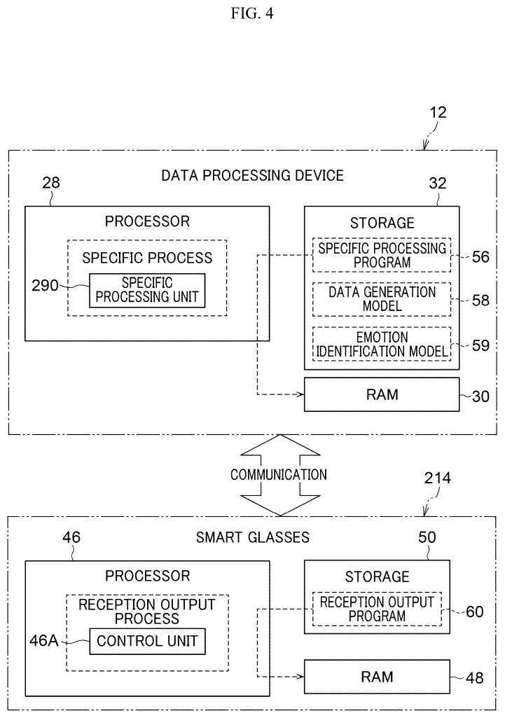

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

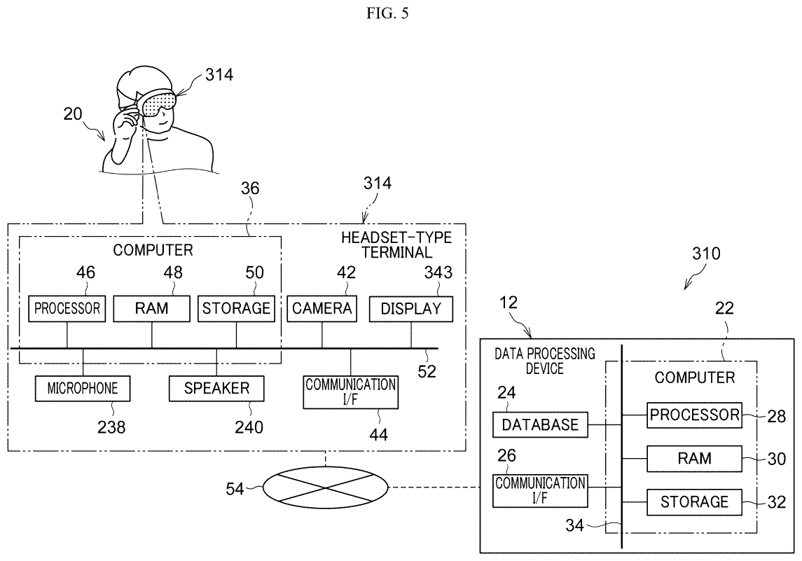

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

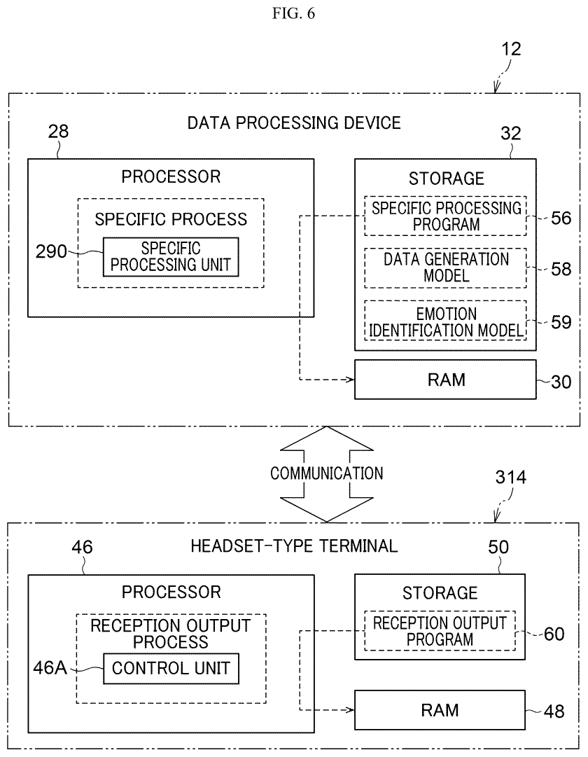

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

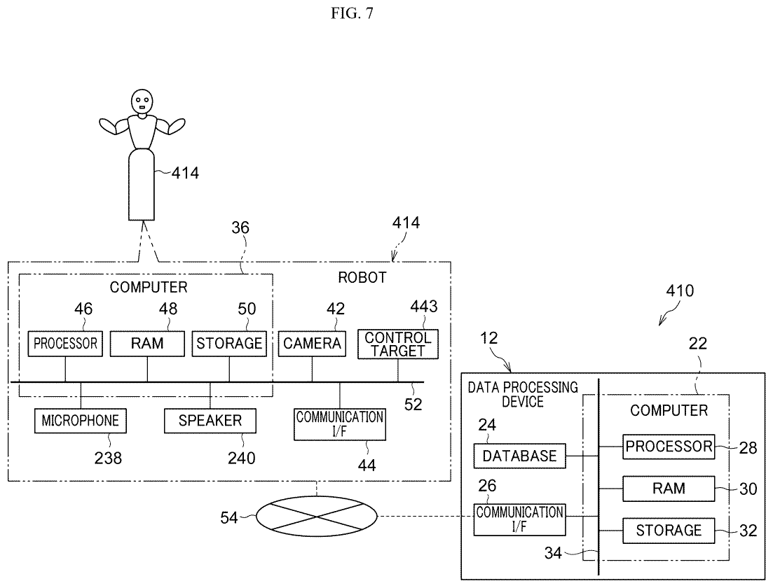

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

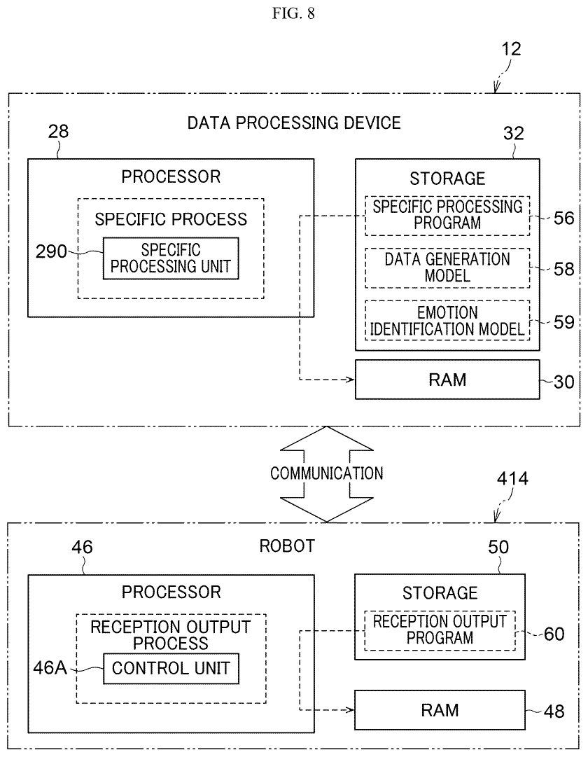

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

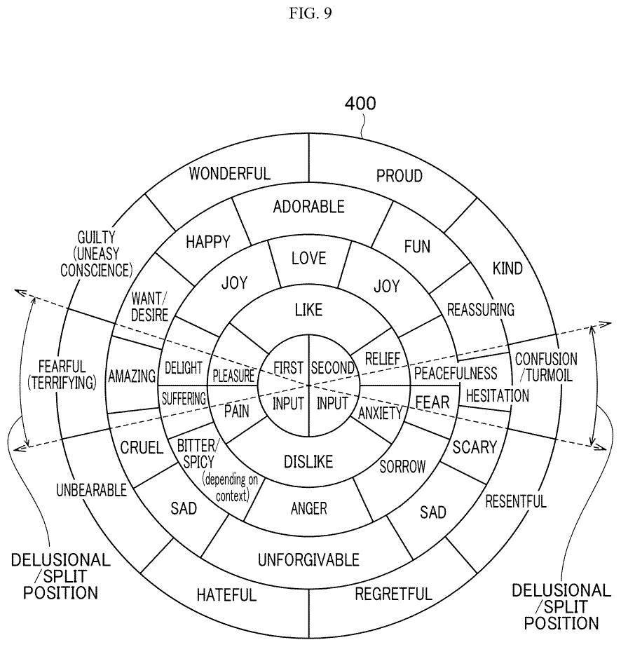

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

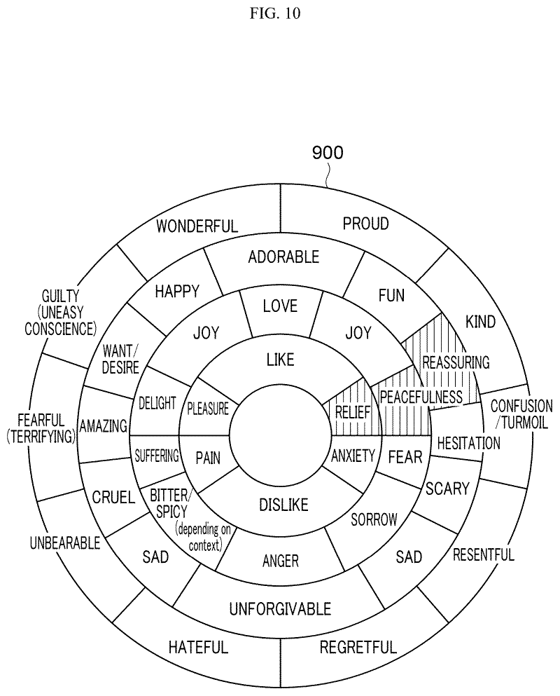

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive consultation information input by a user via a terminal,
analyze the consultation information by using a natural language processing technique to recognize an emotional state of the user,
generate a prompt sentence, based on the consultation information and the emotional state, for causing a generative AI model to perform analysis and response generation,
transmit, to the generative AI model, request data including the prompt sentence and acquire, from the generative AI model, response information including a general opinion and advice,
extract one or more consultation destination candidates based on the response information and the emotional state and identify, from the consultation destination candidates, a specific organizational unit or responsible entity,
convert the response information and the identified organizational unit or responsible entity into display data that is outputtable on a display screen of the terminal and transmit the display data to the terminal via a communication control function, and
receive, via the communication control function, the consultation information transmitted from the terminal and transmit the display data to the terminal.

### Supplementary 2

The system according to supplementary 1,
wherein the processor is configured to
store, as learning target information, the consultation information, compliance-related cases in society, norm information, and past consultation histories, and dynamically generate the prompt sentence that specifies analysis conditions and an output format for the generative AI model in consideration of the stored learning target information and the emotional state.

### Supplementary 3

The system according to supplementary 1,
wherein the processor is configured to
manage, as dialogue history, a plurality of pieces of consultation information transmitted from the terminal and a plurality of pieces of response information acquired from the generative AI model, and incorporate context information including the dialogue history and the emotional state into the prompt sentence so as to perform generation of the general opinion and identification of the consultation destination in response to continuous consultations.

### Application Example 1

### Supplementary 1

A system comprising a processor,
wherein the processor is configured to
receive inquiry information from a user,
analyze the inquiry information by using a natural language processing technique, extract important terms and context information from the inquiry information, and recognize an emotional state of the user,
identify analysis target matters related to compliance issues and information security issues based on the important terms, the context information, and the emotional state,
construct a prompt sentence to be input to a generative AI model based on the analysis target matters and the inquiry information,
input the prompt sentence to the generative AI model and cause the generative AI model to generate analysis result information including a general opinion and a response policy relating to the compliance issues and the information security issues,
search an information storage unit that stores latest regulatory information and latest information security case information based on the analysis result information, acquire related information corresponding to the analysis result information, and add the related information to the analysis result information,
generate advice information to be presented to the user by specifying, based on the analysis result information, the related information, and the emotional state, a consultation contact or a responsible unit inside or outside an organization that the user should refer to,
and output the advice information to a communication terminal.

### Supplementary 2

The system according to supplementary 1,
wherein the processor is configured to
store learning data including public compliance cases, normative information, regulatory information, information security cases, and actual consultation cases, and control the prompt sentence so as to cause the generative AI model to perform analysis in consideration of the learning data and emotional data.

### Supplementary 3

The system according to supplementary 1,
wherein the processor is configured to
adjust, based on the emotional state of the user and an analysis result of the inquiry information, presentation content and presentation format of the analysis result information obtained from the generative AI model and a specification result of the consultation contact or the responsible unit, and generate the advice information so as to reduce a psychological burden of the user.

### Example 2

### Supplementary 1

A system comprising a processor,
wherein the processor is configured to
receive, via a communication line, consultation content relating to compliance from a user and store the consultation content as character information,
analyze the consultation content by applying a natural language processing algorithm to perform word sequence segmentation, part-of-speech tagging, semantic role analysis, and emotion state estimation, and extract keyword information, case-type information, risk-level information, and emotion-state information of the user from the consultation content,
execute a search process on an information storage device in which compliance-related information is accumulated, on the basis of the extracted keyword information and the case-type information, and acquire related information including regulation information, precedent information, and policy information,
construct a prompt sentence in which an analysis result including the consultation content, the extracted case-type information and the risk-level information, and the acquired related information is embedded, and input the prompt sentence into a generative information processing model so as to instruct the generative information processing model to generate generic opinions and advisory information based on the analysis result,
perform a display-formatting process on opinion information and advisory information acquired from the generative information processing model, and, in consideration of the emotion-state information of the user, identify an organizational category or a responsibility category to which the user should address the consultation on the basis of the opinion information and the advisory information, and generate response information including information regarding the identified organizational category or responsibility category, and
transmit the response information toward a terminal of the user and cause the terminal to display the response information.

### Supplementary 2

The system according to supplementary 1,
wherein the processor is configured to
generate the prompt sentence on a premise that the generative information processing model has learned knowledge based on public compliance case information, regulation information, and actual consultation information, and include, in the prompt sentence, the analysis result including the emotion-state information so as to cause the generative information processing model to perform analysis of a compliance case and generation of advisory information.

### Supplementary 3

The system according to supplementary 1,
wherein the processor is configured to
specify, on the basis of the emotion-state information of the user and the opinion information and the advisory information obtained from the generative information processing model, the organizational category or the responsibility category to which the user should address the consultation, and include, in the response information, contact-method information or usage-procedure information relating to the specified organizational category or responsibility category.

### Application Example 2

### Supplementary 1

A system comprising a processor,
wherein the processor is configured to
receive consultation information from a user via a terminal and acquire the consultation information as data,
perform string normalization processing and morphological analysis processing on the consultation information and extract word sequences and context information to generate pre-processed text data,
apply an emotion estimation algorithm to the consultation information or the pre-processed text data to calculate emotion state information representing an emotion category and an emotion intensity and store the emotion state information,
input the pre-processed text data as feature data into a problem-type classification model and probabilistically determine at least one problem type from among a plurality of problem classifications including compliance, work-related issues, security issues, and mental health issues,
generate a prompt sentence, which is an instruction sentence to be given to a generative AI model, based on the consultation information, the emotion state information, and the problem type, the prompt sentence including at least one of an instruction to generate a general opinion, an instruction to list specific countermeasures, and an instruction to present a consultation destination candidate,
transmit inquiry data including the prompt sentence to the generative AI model and obtain response data including general opinion information and countermeasure information from the generative AI model,
search a norm information storage data structure for law information or internal rule information based on the problem type and a keyword included in the response data, and generate advice information by adding the law information or the internal rule information to the response data,
search an organization information storage data structure for affiliation-unit information and role information based on the problem type, the emotion state information, and the response data, and specify a concrete organization or a staff attribute as a consultation destination that the user should consult, and
adjust an expression style of a presentation sentence of the advice information and the consultation destination according to the emotion state information and generate a response message to be presented to the user.

### Supplementary 2

The system according to supplementary 1,
wherein the processor is configured to
generate the prompt sentence by referring to a template data structure prepared for each problem type and embedding the consultation information, the emotion state information, and the problem type into the template data structure so as to specify an operation content, a writing style condition, and an output format of the generative AI model.

### Supplementary 3

The system according to supplementary 1,
wherein the processor is configured to
assign weights to a plurality of consultation destination candidates according to the problem type and the emotion state information, rank the consultation destination candidates based on evaluation values calculated from the weights, and determine, according to a ranking result, the consultation destination to be presented to the user.

What is claimed is:

1. A system comprising:
circuitry configured to:
acquire, via a communication interface coupled to a packet-switched network, input text data from a terminal device;
execute a natural language processing pipeline on the input text data to extract keyword feature vectors and determine an affective state vector of a user by inputting the input text data into a neural network configured to output probability values over a plurality of affective state categories;
input the keyword feature vectors and a category label derived from the keyword feature vectors into a knowledge retrieval operation to retrieve reference data records from an information storage device;
construct an instruction sequence comprising the input text data, the category label, a risk indicator derived from the affective state vector, and the retrieved reference data records, and input the instruction sequence into a generative neural network model comprising a transformer-based architecture to generate analysis output data;
parse output data from the generative neural network model to extract structured segment data, compute similarity scores between feature vectors derived from the structured segment data and attribute vectors of entity records stored in a data store, and select a target entity record by executing a ranking operation weighted by the affective state vector; and
generate response data comprising the structured segment data and the target entity record, adjust an expression parameter of the response data based on the affective state vector, and transmit the response data to the terminal device.

2. The system according to claim 1, wherein the circuitry is configured to normalize the input text data by converting characters to a canonical case, removing control characters, and standardizing character encoding, and tokenize the normalized text data into a token sequence comprising word-level tokens and sentence-level tokens, and perform morphological analysis on each token to determine a lemma and a part-of-speech tag.

3. The system according to claim 2, wherein the circuitry is configured to compute attention-weight importance scores for the token sequence using a transformer encoder, select tokens having importance scores exceeding a threshold as keyword tokens, and construct a dependency graph comprising labeled syntactic edges and semantic edges linking the keyword tokens.

4. The system according to claim 3, wherein the circuitry is configured to determine the affective state vector by applying a pooling operation to contextual embeddings of the token sequence to produce a fixed-length representation, inputting the fixed-length representation into a multi-layer neural network with a softmax output layer trained using cross-entropy loss, and obtaining a probability distribution over affective state categories including at least a high-intensity negative category, a moderate-intensity negative category, and a neutral category.

5. The system according to claim 4, wherein the circuitry is configured to determine the category label by inputting the keyword feature vectors into a multi-class classifier that outputs probability values over a plurality of predefined category classifications, computing cosine similarity between term-weight vectors derived from the keyword feature vectors and taxonomy representative vectors stored for each category classification, and selecting the category label when a combined probability and similarity value exceeds a threshold.

6. The system according to claim 1, wherein the circuitry is configured to construct a query comprising the keyword feature vectors and the category label, execute the query against the information storage device using an inverted index and a vector index, compute relevance scores for retrieved records using term-frequency scoring and embedding similarity, and select reference data records having relevance scores exceeding a relevance threshold.

7. The system according to claim 6, wherein the circuitry is configured to retrieve a template data structure associated with the category label, and insert the input text data, the category label, the risk indicator, the retrieved reference data records, and an output format specification into placeholder fields of the template data structure to form the instruction sequence.

8. The system according to claim 7, wherein the circuitry is configured to set inference parameters for the generative neural network model including a temperature value, a maximum token count, and a sampling strategy, transmit the instruction sequence and the inference parameters to the generative neural network model, and receive the analysis output data as a sequence of output tokens.

9. The system according to claim 1, wherein the generative neural network model comprises an embedding layer that maps input tokens to continuous vectors, a positional encoding layer, a plurality of stacked transformer blocks each comprising a multi-head self-attention sublayer and a feed-forward sublayer with layer normalization, and an output layer that produces probability distributions over a vocabulary, and wherein the circuitry decodes output tokens using at least one of beam search, top-k sampling, or temperature-scaled sampling.

10. The system according to claim 9, wherein the circuitry is configured to detect section headings and delimiter tokens in the output data, segment the output data into a first segment comprising analytical content and a second segment comprising recommended action content, and validate the segments against constraint rules defined in the instruction sequence.

11. The system according to claim 10, wherein the circuitry is configured to scan the first segment and the second segment for prohibited content patterns, and redact or replace portions of the output data that match the prohibited content patterns.

12. The system according to claim 1, wherein the circuitry is configured to generate text embeddings from the structured segment data, compute cosine similarity between the text embeddings and attribute vectors of entity records in the data store, and select candidate entity records having cosine similarity values exceeding an entity selection threshold.

13. The system according to claim 12, wherein the circuitry is configured to assign a weight to each candidate entity record based on the category label, the risk indicator, and the affective state vector, compute a weighted combination ranking score for each candidate entity record, and select as the target entity record the candidate entity record having a highest ranking score.

14. The system according to claim 13, wherein, when the affective state vector indicates a high-intensity negative affective state, the circuitry is configured to increase an adjustment factor applied to candidate entity records associated with a specialized-handling designation, thereby biasing selection of the target entity record toward entity records designated for high-sensitivity handling.

15. The system according to claim 1, wherein the circuitry is configured to adjust the expression parameter by modifying at least one of a politeness parameter, an empathy parameter, a technical detail parameter, and a sentence complexity parameter of the response data based on the affective state vector.

16. The system according to claim 1, wherein the circuitry is configured to store, in association with a session identifier, the input text data, the affective state vector, the analysis output data, and the target entity record, and select context segments from stored session data based on recency and relevance for incorporation into a subsequent instruction sequence.

17. The system according to claim 16, wherein the input text data comprises a compliance consultation describing a workplace situation, the analysis output data comprises a general opinion regarding the workplace situation and guidance for evidence collection, the entity records in the data store comprise records corresponding to a human resources department, a compliance department, a legal department, an external counseling service, and a governmental advisory body, and the circuitry is configured to bias selection of the target entity record toward entity records designated for harassment handling or distress handling when the affective state vector indicates a high-intensity negative affective state.

18. A system comprising:
circuitry configured to:
acquire input text data from a terminal device via a communication interface coupled to a packet-switched network;
execute a natural language processing pipeline on the input text data to extract keyword data and determine an affective state of a user, classify the input text data into a category, and derive a risk indicator from the affective state and the category;
retrieve, from an information storage device, reference data records associated with the category using the keyword data;
construct an instruction sequence comprising the input text data, the category, the risk indicator, and the retrieved reference data records, and input the instruction sequence into a generative neural network model comprising a transformer-based architecture to generate analysis output data;
compute similarity scores between feature vectors derived from the analysis output data and attribute vectors of entity records stored in a data store, and select a target entity record by executing a ranking operation that incorporates the affective state; and
generate response data comprising the analysis output data and the target entity record, and transmit the response data to the terminal device.

19. The system according to claim 18, wherein the circuitry is configured to adjust a presentation style of the response data based on the affective state by modifying at least one of a tone parameter, a detail level parameter, and a complexity parameter, and store the instruction sequence and the response data in association with a session identifier for incorporation into subsequent instruction sequences.

20. A method performed by circuitry, the method comprising:
acquiring, via a communication interface coupled to a packet-switched network, input text data from a terminal device;
executing a natural language processing pipeline on the input text data to extract keyword feature vectors and determining an affective state vector of a user by inputting the input text data into a neural network configured to output probability values over a plurality of affective state categories;
inputting the keyword feature vectors and a category label derived from the keyword feature vectors into a knowledge retrieval operation to retrieve reference data records from an information storage device;
constructing an instruction sequence comprising the input text data, the category label, a risk indicator derived from the affective state vector, and the retrieved reference data records, and inputting the instruction sequence into a generative neural network model comprising a transformer-based architecture to generate analysis output data;
parsing output data from the generative neural network model to extract structured segment data, computing similarity scores between feature vectors derived from the structured segment data and attribute vectors of entity records stored in a data store, and selecting a target entity record by executing a ranking operation weighted by the affective state vector; and
generating response data comprising the structured segment data and the target entity record, adjusting an expression parameter of the response data based on the affective state vector, and transmitting the response data to the terminal device.
